(19) United States
(12) Patent Application Publication
(10) Pub. No.: US 2016/0032148 A1
(43) Pub. Date: Feb. 4, 2016

(54) A METHOD FOR MAKING AN OPTICAL ASSEMBLY COMPRISING DEPOSITING A SOLID SILICONE-CONTAINING HOT MELT COMPOSITION IN POWDER FORM AND FORMING AN ENCAPSULANT THEREOF

(71) Applicants: DOW CORNING CORPORATION, Midland, MI (US); DOW CORNING TORAY CO., LTD., Chiyoda-ku, Tokyo (JP)

(72) Inventors: Masaaki Amako, Chiba (JP); Geoffrey Bruce Gardner, Midland, MI (US); Mayumi Mizukami, Tokyo (JP); Steven Swier, Midland, MI (US); Hiroaki Yoshida, Tokyo (JP); Shin Yoshida, Chiba (JP)

(21) Appl. No.: 14/776,894

(22) PCT Filed: Mar. 12, 2014
(86) PCT No.: PCT/US2014/024374

§ 371 Date: Sep. 15, 2015

Related U.S. Application Data
(60) Provisional application No. 61/792,340, filed on Mar. 15, 2013.

(51) Int. Cl. C09D 183/10; B29C 45/14; B29C 43/00

(52) U.S. Cl. CPC C09D 183/10; B29C 43/00; B29C 45/14811; B29K 2083/00

(57) ABSTRACT

Methods of making optical assemblies and electronic devices comprising, depositing a solid silicone-containing hot melt composition in powder form onto an optical surface of an optical device; and forming, from the silicone-containing hot melt composition, an encapsulant that substantially covers the optical surface of the optical device. In some embodiments, the silicone containing hot melt composition is a reactive or unreactive silicone-containing hot melt. In some embodiments, the composition is a resin-linear silicone-containing hot melt composition and the composition comprises a phase separated resin-rich phase and a phase separated linear-rich phase.

This application claims the benefit of priority to U.S. Provisional Patent Application Ser. No. 61/792,340, filed Mar. 15, 2013, the disclosure of which is incorporated herein in its entirety by reference.

### FIELD

This disclosure generally relates to an powdered resin linear organopolysiloxane compositions and associated methods.

### BACKGROUND

Optical devices, such as optical emitters, optical detectors, optical amplifiers, and the like, may emit or receive light via an optical surface. For various such devices, the optical surface may be or may include an electronic component or other component that may be sensitive to environmental conditions. Certain optical devices such as optoelectronics generally, including light emitting diodes (LEDs), laser diodes, and photosensors, can include solid state electronic components that may be susceptible to electrical shorts or other damage from environmental conditions if not protected. Even optical devices that may not be immediately susceptible may degrade over time if not protected. Accordingly, there is a need in the art for layered polymeric structures that, among other things, protect optical devices from the environment in which they operate.

### SUMMARY

Embodiment 1 relates to a solid silicone-containing hot melt composition in powder form.

Embodiment 2 relates to the silicone-containing hot melt composition of Embodiment 1, wherein the silicone containing hot melt is a reactive silicone-containing hot melt.

Embodiment 3 relates to the silicone-containing hot melt composition of Embodiment 1, wherein the silicone containing hot melt is a non-reactive silicone-containing hot melt.

Embodiment 4 relates to the silicone-containing hot melt composition of Embodiment 1, wherein the composition is a resin-linear silicone-containing hot melt composition and the composition comprises a phase separated resin-rich phase and a phase separated linear-rich phase.

Embodiment 5 relates to the silicone-containing hot melt composition of Embodiment 5, wherein the resin-linear composition comprises:
40 to 90 mole percent disiloxy units of the formula [R¹₂SiO_{2/2}],
10 to 60 mole percent trisiloxy units of the formula [R²SiO_{3/2}],
0.5 to 35 mole percent silanol groups [≡SiOH];
wherein:
each R¹, at each occurrence, is independently a C₁ to C₃₀ hydrocarbyl,
each R², at each occurrence, is independently a C₁ to C₂₀ hydrocarbyl;
wherein:
the disiloxy units [R¹₂SiO_{2/2}] are arranged in linear blocks having an average of from 10 to 400 disiloxy units [R¹₂SiO_{2/2}] per linear block,
the trisiloxy units [R²SiO_{3/2}] are arranged in non-linear blocks having a molecular weight of at least 500 g/mole, and at least 30% of the non-linear blocks are crosslinked with each other, each linear block is linked to at least one non-linear block; and
the organosiloxane block copolymer has a molecular weight of at least 20,000 g/mole.

Embodiment 6 relates to the silicone-containing hot melt composition of Embodiment 1, further comprising one or more phosphors and/or fillers.

Embodiment 7 relates to a solid film made from the silicone-containing hot melt composition of Embodiment 1.

Embodiment 8 relates to the solid film of Embodiment 8, wherein the film is curable.

Embodiment 9 relates to the solid film of Embodiment 8, wherein the film is cured via a curing mechanism.

Embodiment 10 relates to the solid film of Embodiment 9, wherein the curing mechanism comprises a hot melt cure, moisture cure, a hydrosilylation cure, a condensation cure, peroxide cure or a click chemistry-based cure.

Embodiment 11 relates to the solid film of Embodiment 9, wherein the curing mechanism is catalyzed by a curing catalyst.

Embodiment 12 relates to an encapsulant comprising the silicone-containing hot melt composition or film of Embodiments 1-10.

Embodiment 13 relates to a method for making an optical assembly, comprising:
depositing the silicone-containing hot melt composition of Embodiment 1 onto an optical surface of an optical device; and
forming, from the silicone-containing hot melt composition, an encapsulant that substantially covers the optical surface of the optical device.

Embodiment 14 relates to the method of Embodiment 13, wherein the depositing and/or forming of the encapsulant comprises at least one of compression molding, lamination, extrusion, fluidized bed coating, electrophoretic deposition, injection molding, melt processing, electrostatic coating, electrostatic powder coating, electrostatic fluidized bed coating, transfer molding, magnetic brush coating.

Embodiment 15 relates to the method of Embodiment 13, further comprising depositing the silicone-containing hot melt composition of Embodiment 1 onto a substrate to which the optical device is mechanically coupled.

Embodiment 16 relates to the method of Embodiment 13, wherein depositing the silicone-containing hot melt composition onto the optical surface comprises forming a first layer, and further comprising depositing a silicone-containing hot melt composition in a second layer on top of the first layer.

Embodiment 17 relates to a method for depositing the silicone-containing hot melt composition of Embodiment 1 onto a substrate.

Embodiment 18 relates to the method of Embodiment 17, wherein the depositing comprises at least one of compression molding, lamination, extrusion, fluidized bed coating, electrophoretic deposition, injection molding, melt processing, electrostatic coating, electrostatic powder coating, electrostatic fluidized bed coating, transfer molding, magnetic brush coating.

Embodiment 19 relates to a method of making an optical assembly comprising:
securing an optical device with respect to a substrate;
depositing the silicone-containing hot melt composition of Embodiment 1 onto at least one of a substrate and an optical surface of the optical device.

Embodiment 20 relates to the method of claim 19, wherein the optical device is secured to the substrate prior to depositing the silicone-containing hot melt.

Embodiment 21 relates to the method of Embodiment 19, wherein depositing the silicone-containing hot melt composition substantially covers an entire area of the substrate.

Embodiment 22 relates to the method of Embodiment 19, wherein depositing the silicone-containing hot melt composition substantially only covers an area of the substrate between the substrate and the optical device.

Embodiment 23 relates to the method of Embodiment 19, wherein depositing the silicone-containing hot melt composition substantially only covers an area of the substrate not covered by the optical device.

Embodiment 24 relates to the method of Embodiment 19, wherein depositing the silicone-containing hot melt composition substantially covers only an area of the substrate not covered by the optical device and an optical surface of the optical device.

Embodiment 25 relates to the method of Embodiment 19, further comprising depositing a thin film encapsulant on the optical surface of the optical device, and wherein depositing the silicone-containing hot melt deposits the silicone-containing hot melt, at least in part, on the thin film encapsulant.

Embodiment 26 relates to the method of Embodiment 19, wherein depositing the silicone-containing hot melt forms a first layer of the silicone-containing hot melt, and further comprising depositing a second layer of the silicone-containing hot melt substantially on top of the first layer.

Embodiment 27 relates to the method of Embodiment 19, further comprising forming an encapsulant configured to encapsulate, at least in part, the optical device.

Embodiment 28 relates to the method of Embodiment 27, wherein depositing the silicone-containing hot melt deposits the silicone containing hot melt, at least in part, on the encapsulant.

Embodiment 29 relates to the method of Embodiment 27, wherein the silicone-containing hot melt is mixed with the encapsulant, and wherein depositing the silicone-containing hot melt composition comprises depositing both the silicone-containing hot melt composition and the encapsulant as a single composition.

Embodiment 30 relates to a method of making an optical assembly comprising:
securing an optical device with respect to a substrate;
encapsulating, at least in part, the optical device with an encapsulant; and
depositing the silicone-containing hot melt composition of Embodiment 1 onto the encapsulant.

Embodiment 31 relates to the method of Embodiment 30, wherein the encapsulant is a first encapsulant, and further comprising forming a second encapsulant on the silicone-containing hot melt composition, wherein the silicone-containing hot melt composition is between, at least in part, the first encapsulant and the second encapsulant.

Embodiment 32 relates to a method of making an electronic device comprising:
securing an electronic component with respect to a substrate; and
depositing the silicone-containing hot melt composition of claim 1 onto the electronic component.

Embodiment 33 relates to the method of Embodiment 32, wherein the electronic device is at least one of a plastic leaded chip carrier (PLCC), a power package, a single-chip-on-board and a multi-chip-on-board.

Embodiment 34 relates to the method of Embodiment 32, further comprising forming, from the silicone-containing hot melt composition, an encapsulant that substantially covers the electronic component.

Embodiment 35 relates to the method of Embodiment 32, further comprising forming an encapsulant that substantially covers the electronic component and the silicone-containing hot melt composition.

### FIGURES

FIG. 1 is a depiction of an optical assembly with a silicone-containing hot melt composition layer substantially covering a substrate.

FIG. 2 is a depiction of an optical assembly with a silicone-containing hot melt composition layer partially covering a substrate.

FIG. 3 is a depiction of an optical assembly with a silicone-containing hot melt composition layer partially covering a substrate.

FIG. 4 is a depiction of an optical assembly with a silicone-containing hot melt composition layer partially covering a substrate, an optical device, and a color conversion layer.

FIG. 5 is a depiction of an optical assembly with a silicone-containing hot melt composition layer at least partially covering an optical device.

FIG. 6 is a depiction of an optical assembly with multiple silicone-containing hot melt composition layers at least partially covering an optical device.

FIG. 7 is a depiction of an optical assembly with multiple silicone-containing hot melt composition layers at least partially covering an optical device.

FIG. 8 is a depiction of an optical assembly with a silicone-containing hot melt composition layer at least partially covering an encapsulant.

FIG. 9 is a depiction of an optical assembly with a silicone-containing hot melt composition mixed with an encapsulant.

FIG. 10 is a depiction of an optical assembly with a silicone-containing hot melt composition layer on top of an encapsulant.

FIG. 11 is a depiction of an optical assembly with a silicone-containing hot melt composition layer between two encapsulant layers.

FIG. 12 is a depiction of an optical assembly with a silicon-containing hot melt composition forming a reflector and/or dam to enclose, at least in part, an encapsulant.

FIG. 13 is a depiction of an optical assembly with a silicone-containing hot melt composition layer acting as a bonding agent between a film and the substrate.

FIG. 14 is black-and-white pictures, and one scanning electron micrograph (SEM), of solid forms of a silicon-containing hot melt composition. The SEM is of the powder solid form of a silicon-containing hot melt composition.

### DETAILED DESCRIPTION

This disclosure generally relates to a powdered hot melt compositions (e.g., silicone hot melt compositions) and associated methods for their use. Such powdered hot melt compositions present some significant advantages over, e.g., film compositions. One such advantage is that powdered hot melt compositions provide the ability to more easily coat three-dimensional features (e.g., an optical assemblies; features having sharp aspect ratios, including corners, such as those present on LED chips; substantially tall vertical features; wires that make electrical contacts, etc.) that would otherwise be difficult to coat with, e.g., film compositions. For example, hot melt powdered compositions provide the ability to coat three-dimensional features such that there are no substantial air gaps between the three-dimensional feature and the film that is formed from the hot melt composition. Another advantage presented by powdered hot melt compositions is the ability to introduce a color conversion layer on chips that would otherwise be difficult to laminate with a film.

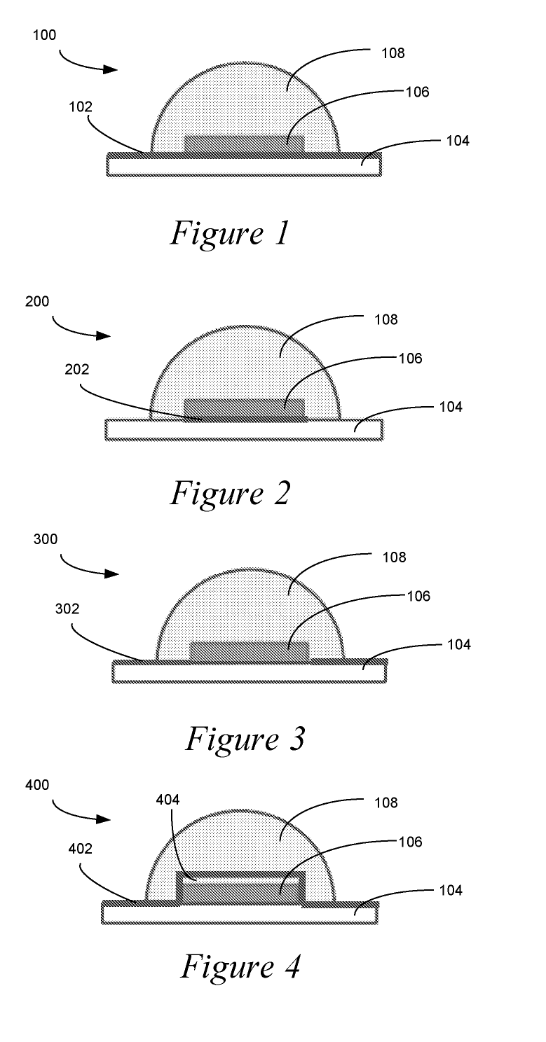

FIG. 1 is a depiction of an optical assembly 100 with a silicone-containing hot melt composition layer 102 substantially covering a substrate 104. The optical assembly 100 may be formed by depositing the layer 102 in powder form on the substrate 104, then securing an optical device 106 with respect to the substrate 104 and encapsulating the optical device 106 with an encapsulant 108. In various examples, the layer 102 may be heated and melted prior to or concurrently with securing the optical device 106 and/or applying the encapsulant 108. The layer 102 may function as a bonding agent to bond the optical device 106 to the substrate. With respect to the illustrated example and to the rest of the illustrated examples disclosed herein, the optical device 106 may more generally be a silicon die and may be attached in a flip chip configuration to the substrate using the layer 102 as a bonding material. They layer 102 include TiO₂ or other whitener and/or may contain thermally conductive particles.

In some embodiments, the silicone-containing hot melt compositions described herein may be used to encapsulate any electronic device that could benefit from having an encapsulant substantially overlaying the device or portion of the device. Such electronic devices include, but are not limited to plastic leaded chip carriers (PLCCs), power packages (single or multichip), single-chip-on-board or “multi-chip-on-board.” See, e.g., U.S. Pat. No. 6,942,360, which is incorporated by reference as if fully set forth herein, for an example of a multi-chip-on-board device.

FIG. 2 is a depiction of an optical assembly 200 with a silicone-containing hot melt composition layer 202 partially covering a substrate 104. In particular, the layer 202 may act as a bonding material for the optical device 106. The layer 202 may be deposited on the substrate 104 and the optical device 106 attached to the layer 202. The encapsulant 108 may be applied as disclosed herein. The layer 202 may include thermally conductive particles for thermally conductive die attach or whitener particles to make they layer 202 reflective, in part.

“Hot melt” compositions of the various examples and embodiments described herein may be reactive or unreactive. Reactive hot melt materials are chemically curable thermoset products which, after curing, are high in strength and resistant to flow (i.e., high viscosity) at room temperature. The viscosity of hot melt compositions tend to vary significantly with changes in temperature from being highly viscous at relatively low temperatures (e.g., at or below room temperature) to having comparatively low viscosities as temperatures increase towards a target temperature sufficiently higher than a working temperature, such as room temperature. In various examples, the target temperature is 200° C. Reactive or non-reactive hot melt compositions are generally applied to a substrate at elevated temperatures (e.g., temperatures greater than room temperature, for example greater than 50° C.) as the composition is significantly less viscous at elevated temperatures (e.g., at temperatures from about 50 to 200° C.) than at room temperature or thereabouts. In some cases, hot melt compositions are applied on to substrates at elevated temperatures as flowable masses and are then allowed to quickly “resolidify” merely by cooling. Other application methods include the application of sheets of hot melt material on, e.g., a substrate or superstrate, at room temperature, followed by heating.

FIG. 3 is a depiction of an optical assembly 300 with a silicone-containing hot melt composition layer 302 partially covering a substrate 104. In particular, the layer 202 may free bond pads for a thermally conductive layer 202. Whitener particles may make the layer 202 at least partially reflective.

FIG. 4 is a depiction of an optical assembly 400 with a silicone-containing hot melt composition layer 402 partially covering a substrate 104, an optical device 106, and a color conversion layer 404, such as a phosphor layer. The layer 402 may provide for color whitening and/or act as an encapsulant of the color conversion layer 404.

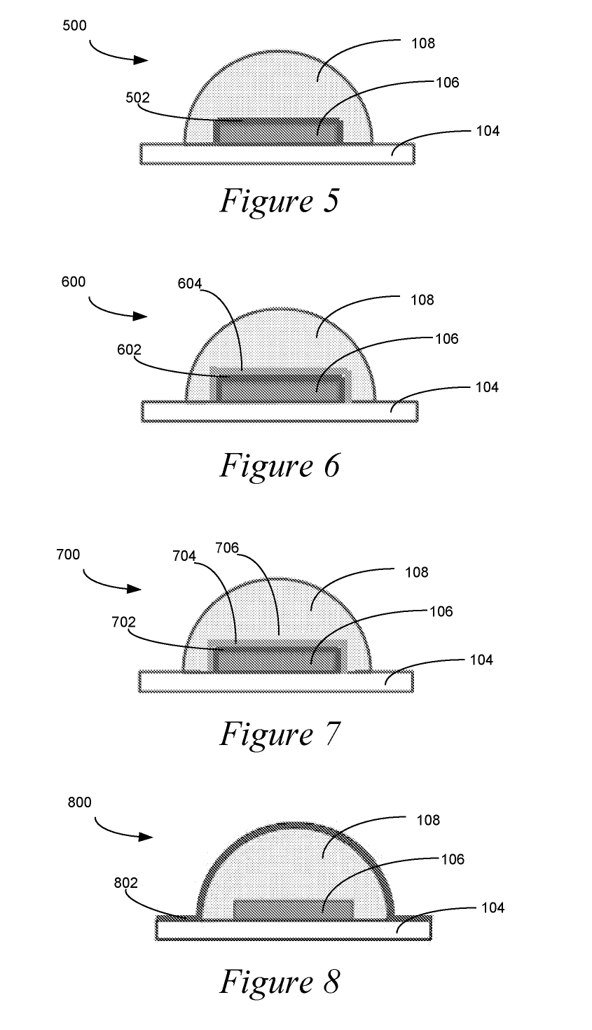

FIG. 5 is a depiction of an optical assembly 500 with a silicone-containing hot melt composition layer 502 at least partially covering an optical device 106. The layer 502 may, in various examples, be mixed with a phosphor to provide color conversion. In various examples, the layer 502 may further coat the substrate 104 as in FIG. 4. The layer 502 may have a refractive index that matches or otherwise compliments the refractive index of the optical device 106.

FIG. 6 is a depiction of an optical assembly 600 with multiple silicone-containing hot melt composition layers 602, 604 at least partially covering an optical device 106. The layers 602, 604 are not limited and the optical assembly 600 may incorporate more layers 602, 604 than illustrated. The various layers 602, 604 may be or include some or all of a phosphor layer, a barrier layer, a whitening layer, and a thermally conductive layer. The layers 602, 604 may form a layered polymeric structure, as disclosed herein. In various examples, the layers 602, 604 may further coat the substrate 104 as in FIG. 4.

FIG. 7 is a depiction of an optical assembly 700 with multiple silicone-containing hot melt composition layers 702, 704, 706 at least partially covering an optical device 106. The layers 702, 704, 706 may be applied by being deposited in multiple coats. Each layer 702, 704, 706 may incorporate a different phosphor. The layers 702, 704, 706 may form a layered polymeric structure, as disclosed herein. In various examples, the layers 702, 704, 706 may further coat the substrate 104 as in FIG. 4.

FIG. 8 is a depiction of an optical assembly 800 with a silicone-containing hot melt composition layer 802 at least partially covering an encapsulant 108. The layer 800 may include a phosphor or otherwise act as a barrier, and optionally coats the substrate 104.

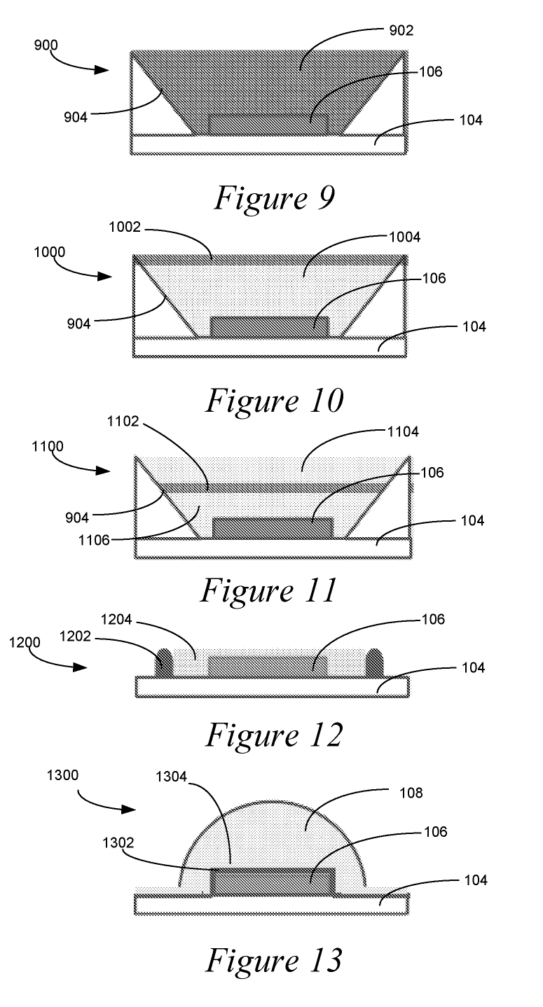

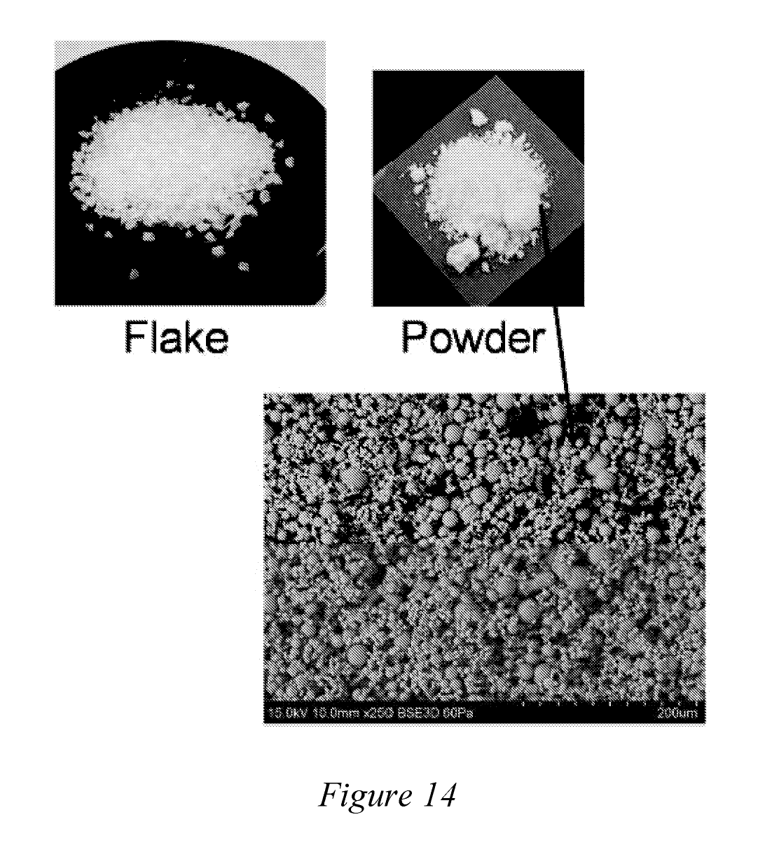

FIG. 9 is a depiction of an optical assembly 900 with a silicone-containing hot melt composition mixed with an encapsulant 902. The silicone-containing hot melt composition may be clear or may include a phosphor. The optical device 106 is seated within reflective surfaces 904.

FIG. 10 is a depiction of an optical assembly 1000 with a silicone-containing hot melt composition layer 1002 on top of an encapsulant 1004. The layer 1002 may be applied external relative to the encapsulant 1004 to provide a desired refractive index, such as to smooth a transition between air and the encapsulant 1004.

FIG. 11 is a depiction of an optical assembly 1100 with a silicone-containing hot melt composition layer 1102 between two encapsulant layers 1104, 1006. The layer 1102 may provide a refractive index transition or matching between the two encapsulant layers 1104, 1106.

FIG. 12 is a depiction of an optical assembly 1200 with a silicon-containing hot melt composition 1202 forming a reflector and/or dam to enclose, at least in part, an encapsulant 1204. The composition 1202 may be compression molded to form the reflector and/or dam.

FIG. 13 is a depiction of an optical assembly 1300 with a silicone-containing hot melt composition layer 1302 acting as a bonding agent between a film 1304 and the substrate 104.

The silicon-containing hotmelt compositions described herein are solids (hereinafter described as the “solid composition”). The solid composition is “solid,” as understood in the art. For example, the solid composition has structural rigidity, resists to changes of shape or volume, and is not a liquid or a gel. In one example, the solid composition may be a pellet, spheroid, ribbon, sheet, cube, powder (e.g., a powder having an average particle size of not more than 500 μm, including a powder having an average particle size of from about 5 to about 500 μm; from about 10 to about 100 μm; from about 10 to about 50 μm; from about 30 to about 100 μm; from about 50 to about 100 μm; from about 50 to about 250 μm; from about 100 to about 500 μm; from about 150 to about 300 μm; or from about 250 to about 500 μm), flake, etc. The dimensions of the solid composition are not particularly limited. In various embodiments, the solid composition is as described in described in U.S. Provisional Patent Application Ser. No. 61/581,852, filed Dec. 30, 2011; PCT Application No. PCT/US2012/071011, filed Dec. 30, 2012; U.S. Provisional Patent Application Ser. No. 61/586,988, filed Jan. 16, 2012; and PCT Application No. PCT/US2013/021707, filed Jan. 16, 2013, all of which are hereby expressly incorporated herein by reference.

The solid compositions described herein may be deposited onto a substrate to, e.g., form at least a portion of an optical assembly. The solid compositions may be deposited by various methods known in the art, including compression molding, lamination, extrusion, fluidized bed coating, electrophoretic deposition, injection molding, melt processing, electrostatic coating, electrostatic powder coating, electrostatic fluidized bed coating, transfer molding, magnetic brush coating. The solid compositions may be deposited in discrete regions of a substrate or may be deposited to form a layer (e.g., a layer of powder on a portion of a substrate or as a layer substantially covering an entire substrate). The solid compositions may then be melted to form, e.g., layered polymeric structures. Such layered polymeric structures may include a body that may include a silicone-containing hotmelt composition or may be made wholly of a silicone-containing hotmelt composition, such as is described in detail herein. The body may incorporate multiple layers of silicone-containing hot melt composition. The body may include phosphors and may be formed so as to create a gradient of various characteristics. In various examples, the layered polymeric structure is between about 0.5 microns and five (5) millimeters thick.

In various examples, the solid compositions may include a resin-linear composition as described in greater detail herein.

A layered polymeric structure made from solid compositions may also include or, in various examples, be attached to a release liner. The release liner may include a release agent for the promotion of securing the layered polymeric structure to another object, such as an optical device. In various examples, the release liner is or includes siliconized PET or a fluorinated liner. In various examples, the release liner is smooth or is textured, such as to act as an anti-reflective surface.

In various examples, when the solid compositions are deposited as a layer (e.g., deposited as a layer on a portion of a substrate or as a layer substantially covering an entire substrate), there may be a single layer or more than one layer. Those of skill in the art will recognize that there may be a need to at least melt the first layer before a subsequent layer is deposited.

When there are multiple layers that form a layered polymeric structure, each layer may contain silicone-containing hot melt compositions. In some examples, each layer may include different chemistries (e.g., curing chemistries) and/or different material properties, including mechanical properties or optical properties. The differences (e.g., chemistry and/or material properties) between layers may be minor or may incorporate significant differences. In various examples disclosed herein, each layer has material properties, such as a modulus, a hardness, a refractive index, a transmittance or a thermal conductivity that may be different from other layers. In addition to the chemistry and material property differences between layers (i.e., when multiple layers are present), in some embodiments, there may also be structural differences between layers. For example, removal or non-incorporation of a release liner may provide for a layer to have a major surface that is or may be exposed to environmental conditions. The major surface may be rough or roughened, in whole or in part, or may substantially repel dust.

Layers of a layered polymeric structure can be secured with respect to one another through various processes disclosed herein, including lamination and through the use of catalysts. Layers of a layered polymeric structure may be individually cured or not cured as appropriate to the particular compositions used therein. In an example, only one of the layers in a layered polymeric structure is cured, while the other one of the layers in the layered polymeric structure may set without curing. In an example, each of the layers of the layered polymeric structure is cured, but each layer of the layered polymeric structure may cure at different cure speeds. In various examples, each layer of the layered polymeric structure may have the same or different curing mechanisms. In an example, at least one of the curing mechanisms of the layers of the layered polymeric structure include a hot melt cure, moisture cure, a hydrosilylation cure (as described herein), a condensation cure, peroxide/radical cure, photo cure or a click chemistry-based cure that involves, in some examples, metal-catalyzed (copper or ruthenium) reactions between an azide and an alkyne or a radical-mediated thiol-ene reactions.

The curing mechanisms of layers of the layered polymeric structure may include combinations of one or more cure mechanisms within the same layer of the layered polymeric structure or in each layer of the layered polymeric structure. For example, the curing mechanism within the same layer of the layered polymeric structure may include a combination of a hydrosilylation and a condensation cure, where the hydrosilylation occurs first and is followed by the condensation cure or vice versa (e.g., hydrosilylation/alkoxy or alkoxy/hydrosilylation); a combination of a ultra-violet photo cure and a condensation cure (e.g., UV/alkoxy); a combination of a silanol and an alkoxy cure; a combination of a silanol and hydrosilylation cure; or a combination of an amide and a hydrosilylation cure.

When more than one layer is present in the layered polymeric structure, two layers of the layered polymeric structure that are in contact with one another (e.g., direct contact) can utilize different curing catalysts, such as may be incompatible with one another. In some examples, such an arrangement would cause the catalysts to “poison” each other such that there is an incomplete cure at the interface between the two layers of the layered polymeric structure. In various examples, each layer of the layered polymeric structure individually selectably has reactive or non-reactive silicone-containing hot melt compositions.

Cure catalysts are those known in the art to catalyze the curing of silicone-containing compositions, such as those described herein. Such catalysts include condensation cure catalysts and hydrosilylation cure catalysts. Representative condensation cure catalysts include, but are not limited to tetravalent tin-containing metal ligand complex capable of promoting and/or enhancing the cure of the compositions described herein. In some embodiments, the tetravalent tin-containing metal ligand complex is a dialkyltin dicarboxylate. In some embodiments, the tetravalent tin-containing metal ligand complex includes those comprising one or more carboxylate ligands including, but not limited to, dibutyltin dilaurate, dimethyltin dineodecanoate, dibutyltin diacetate, dimethylhydroxy(oleate)tin, dioctyldilauryltin, and the like. Other condensation cure catalysts include Al(acac)₃ and superbases such as DBU.

Other cure catalysts include hydrosilylation cure catalysts. Such catalysts include Group VIII metal based catalyst selected from a platinum, rhodium, iridium, palladium or ruthenium. Representative hydrosilylation cure catalysts include, but are not limited to, the catalyst described in U.S. Pat. No. 2,823,218 (e.g.,“Speier's catalyst”) and U.S. Pat. No. 3,923,705, the entireties of both of which are incorporated by reference as if fully set forth herein; and “Karstedt's catalyst,” which is described in U.S. Pat. Nos. 3,715,334 and 3,814,730, both of which are incorporated by reference as if fully set forth herein.

In one example, the solid compositions described herein include a phosphor and/or a filler. The phosphor and/or filler may be added to the solid compositions (e.g., a power) before they are deposited onto, e.g., a substrate, or after they are deposited onto, e.g., a substrate. In an example, the phosphor is made from a host material and an activator, such as copper-activated zinc sulfide and silver activated zinc sulfide. The host material may be selected from a variety of suitable materials, such as oxides, nitrides and oxynitrides, sulfides, selenides, halides or silicates of zinc, cadmium, manganese, aluminum, silicon, or various rare earth metals, Zn₂SiO₄:Mn (Willemite); ZnS:Ag+(Zn,Cd)S:Ag; ZnS:Ag+ZnS:Cu+Y₂O₂S:Eu; ZnO:Zn; KCl; ZnS:Ag,Cl or ZnS:Zn; (KF,MgF₂):Mn; (Zn,Cd)S:Ag or (Zn,Cd)S:Cu; Y₂O₂S:Eu+Fe₂O₃, ZnS:Cu,Al; ZnS:Ag+Co-on-Al₂O₃;(KF,MgF2):Mn; (Zn,Cd)S:Cu,Cl; ZnS:Cu or ZnS:Cu,Ag; MgF₂:Mn; (Zn,Mg)F₂:Mn; Zn₂SiO₄:Mn,As; ZnS:Ag+(Zn,Cd)S:Cu; Gd₂O₂S:Tb; Y₂O₂S:Tb; Y₃Al₅O₁₂:Ce; Y₂SiO₅:Ce; Y₃Al₅O₁₂:Tb; ZnS:Ag,Al; ZnS:Ag; ZnS:Cu,Al or ZnS:Cu,Au,Al; (Zn,Cd)S:Cu,Cl+(Zn,Cd)S:Ag,Cl; Y₂SiO₅:Tb; Y₂OS:Tb; Y₃(Al,Ga)₅O₁₂:Ce; Y₃(Al,Ga)₅O₁₂:Tb; InBO₃:Tb; InBO₃:Eu; InBO₃:Tb+InBO₃:Eu; In BO₃:Tb+In BO₃:Eu+ZnS:Ag; (Ba,Eu)Mg₂Al₁₆O₂₇; (Ce,Tb)MgAl₁₁O₁₉; BaMg Al₁₀O₁₇:Eu,Mn; BaMg₂Al₁₆O₂₇:Eu(II); BaMgAl₁₀O₁₇:Eu,Mn; BaMg₂Al₁₆O₂₇:Eu(II),Mn(II); Ce_{0.67}Tb_{0.33}MgAl₁₁O₁₉:Ce,Tb; Zn₂SiO₄:Mn,Sb₂O₃; CaSiO₃:Pb,Mn; CaWO₄ (Scheelite); CaWO₄:Pb; MgWO₄; (Sr,Eu,Ba,Ca)₅(PO₄)₃Cl; Sr₅Cl(PO₄)₃:Eu(II); (Ca,Sr,Ba)₃(PO₄)₂Cl₂:Eu; (Sr,Ca,Ba)₁₀(PO₄)₆Cl₂:Eu; Sr₂P₂O₇:Sn(II); Sr₆P₅BO₂₀:Eu; Ca₅F(PO₄)₃:Sb; (Ba,Ti)₂P₂O₇:Ti; 3Sr₃(PO₄)₂.SrF₂:Sb,Mn; Sr₅F(PO₄)₃:Sb,Mn; Sr₅F(PO₄)₃:Sb,Mn; LaPO₄:Ce,Tb; (La,Ce,Tb)PO₄;(La,Ce,Tb)PO₄:Ce,Tb; Ca₃(PO₄)₂CaF₂:Ce,Mn; (Ca,Zn,Mg)₃(PO4)₂:Sn; (Zn,Sr)₃(PO₄)₂:Mn; (Sr,Mg)₃(PO₄)₂:Sn; (Sr,Mg)₃(PO₄)₂:Sn(II); Ca₅F(PO₄)₃:Sb,Mn; Ca₅(F,Cl)(PO₄)₃:Sb,Mn; (Y,Eu)₂O₃; Y₂O₃:Eu(III); Mg₄(F)GeO₆:Mn; Mg₄(F)(Ge,Sn)O₆:Mn; Y(P,V)O₄:Eu; YVO₄:Eu; Y₂O₂S:Eu; 3.5 MgO.0.5 MgF₂.GeO₂ :Mn; Mg₅As₂O₁₁:Mn; SrAl₂O₇:Pb; LaMgAl₁₁O₁₉:Ce; LaPO₄:Ce; SrAl₁₂O₁₉:Ce; BaSi₂O₅:Pb; SrFB₂O₃:Eu(II); SrB₄O₇:Eu; Sr₂MgSi₂O₇:Pb; MgGa₂O₄:Mn(II); Gd₂O₂S:Tb; Gd₂O₂S:Eu; Gd₂O₂S:Pr; Gd₂O₂S:Pr,Ce,F; Y₂O₂S:Tb; Y₂O₂S:Eu; Y₂O₂S:Pr; Zn(0.5)Cd(0.4)S:Ag; Zn(0.4)Cd(0.6)S:Ag; CdWO₄; CaWO₄; MgWO₄; Y₂SiO₅:Ce;YAlO₃:Ce; Y₃Al₅O₁₂:Ce; Y₃(Al,Ga)₅O₁₂:Ce; CdS:In; ZnO:Ga; ZnO:Zn; (Zn,Cd)S:Cu,Al; ZnS:Cu,Al,Au; ZnCdS:Ag,Cu; ZnS:Ag; anthracene, EJ-212, Zn2SiO4:Mn; ZnS:Cu; Nal:Tl; Csl:Tl; LiF/ZnS:Ag; LiF/ZnSCu,Al,Au, and combinations thereof.

The amount of phosphor added may vary and is not limiting. When present, the phosphor may be added in an amount ranging from about 0.1% to about 95%, e.g., from about 5% to about 80%, from about 1% to about 60%; from about 25% to about 60%; from about 30% to about 60%; from about 40% to about 60%; from about 50% to about 60%; from about 25% to about 50%; from about 25% to about 40%; from about 25% to about 30%; from about 30% to about 40%; from about 30% to about 50%; or from about 40% to about 50%; based on the total weight of the composition.

The filler, when present, may comprise a reinforcing filler, an extending filler, a conductive filler, or a combination thereof. The filler, when present, may be added in an amount ranging from about 0.1% to about 95%, e.g., from about 2% to about 90%, from about 1% to about 60%; from about 25% to about 60%; from about 30% to about 60%; from about 40% to about 60%; from about 50 to about 60%; from about 25% to about 50%; from about 25% to about 40%; from about 25% to about 30%; from about 30% to about 40%; from about 30% to about 50%; or from about 40% to about 50%; based on the total weight of the composition.

Non-limiting examples of suitable reinforcing fillers include carbon black, zinc oxide, magnesium carbonate, aluminum silicate, sodium aluminosilicate, and magnesium silicate, as well as reinforcing silica fillers such as fume silica, silica aerogel, silica xerogel, and precipitated silica. Fumed silicas are known in the art and commercially available; e.g., fumed silica sold under the name CAB-O-SIL by Cabot Corporation of Massachusetts, U.S.A.

Non-limiting examples of extending fillers include crushed quartz, aluminum oxide, magnesium oxide, calcium carbonate such as precipitated calcium carbonate, zinc oxide, talc, diatomaceous earth, iron oxide, clays, mica, chalk, titanium dioxide, zirconia, sand, carbon black, graphite, or a combination thereof. Extending fillers are known in the art and commercially available; such as a ground silica sold under the name MIN-U-SIL by U.S. Silica of Berkeley Springs, W. Va. Suitable precipitated calcium carbonates include Winnofil® SPM from Solvay and Ultrapflex® and Ultrapflex® 100 from SMI.

Conductive fillers may be thermally conductive, electrically conductive, or both. Conductive fillers are known in the art and include metal particulates (such as aluminum, copper, gold, nickel, silver, and combinations thereof); such metals coated on nonconductive substrates; metal oxides (such as aluminum oxide, beryllium oxide, magnesium oxide, zinc oxide, and combinations thereof), meltable fillers (e.g., solder), aluminum nitride, aluminum trihydrate, barium titanate, boron nitride, carbon fibers, diamond, graphite, magnesium hydroxide, onyx, silicon carbide, tungsten carbide, and a combination thereof. Alternatively, other fillers may be added to the composition, the type and amount depending on factors including the end use of the cured product of the composition. Examples of such other fillers include magnetic particles such as ferrite; and dielectric particles such as fused glass microspheres, titania, and calcium carbonate.

In one embodiment, the filler comprises alumina.

In various examples, layered polymeric structures made from solid compositions may include a phosphor and/or a filler dispersed therein or the phosphor may be a discrete layer. In other words, the phosphor may be present in an independent layer from the layered polymeric structures made from solid compositions may include a phosphor.

In an example, the layered polymeric structures made from solid compositions comprise a gradient of disiloxy units and trisiloxy units. In another example, the layered polymeric structures made from solid compositions includes a gradient of disiloxy units, trisiloxy units, and silanol groups. In still another example, the layered polymeric structures made from solid compositions includes a gradient of trisiloxy units and silanol groups. In a further example, the layered polymeric structures made from solid compositions includes a gradient of disiloxy units and silanol groups. In addition, layered polymeric structures made from solid compositions ranging in refractive index can be used to prepare a composition gradient. For example, a phenyl-T-PDMS resin-linear with refractive index of 1.43 can be combined with a phenyl-T-PhMe resin-linear with a refractive index of 1.56 to create a gradient. Such an example may provide a relatively smooth transition from a high refractive index optical device, such as an LED, to an air surface.

Various alternative examples of layered polymeric structures made from solid compositions are contemplated, including certain combinations of layers utilized therein. In an example, the layered polymeric structure includes one layer with a phosphor, one clear layer, and one layer with a gradient in a reflective index. Various layered polymeric structures can incorporate a glue, such as part of the release layer or in addition to the depicted layers. In various examples, the glue can contribute to curing, such as for a phosphor layer.

### Optical Assemblies

The optical assemblies disclosed herein may have various architectures. For example, the optical assembly may include only an optical device and a layered polymeric structure. The layered polymeric structure may act as an encapsulant or may be positioned relative to a separate encapsulant as disclosed herein. Alternatively, the optical assembly may further include a release liner disposed on or with respect to the encapsulant and/or the optical device.

The optical assembly may be in various known applications, such as in photovoltaic panels and other optical energy-generating devices, optocouplers, optical networks and data transmission, instrument panels and switches, courtesy lighting, turn and stop signals, household appliances, VCR/DVD/stereo/audio/video devices, toys/games instrumentation, security equipment, switches, architectural lighting, signage (channel letters), machine vision, retail displays, emergency lighting, neon and bulb replacement, flashlights, accent lighting full color video, monochrome message boards, in traffic, rail, and aviation applications, in mobile phones, personal digital assistants (PDAs), digital cameras, lap tops, in medical instrumentation, bar code readers, color & money sensors, encoders, optical switches, fiber optic communication, and combinations thereof.

The optical devices can include coherent light sources, such as various lasers known in the art, as well as incoherent light sources, such as light emitting diodes (LED) and various types of light emitting diodes, including semiconductor LEDs, organic LEDs, polymer LEDs, quantum dot LEDs, infrared LEDs, visible light LEDs (including colored and white light), ultraviolet LEDs, and combinations thereof.

The optical assembly may also include one or more layers or components known in the art as typically associated with optical assemblies. For example, the optical assembly may include one or more drivers, optics, heat sinks, housings, lenses, power supplies, fixtures, wires, electrodes, circuits, and the like.

The optical assembly may also include a substrate and/or a superstrate. The substrate may provide protection to a rear surface of the optical assembly while a superstrate may provide protection to a front surface of the optical assembly. The substrate and the superstrate may be the same or may be different and each may independently include any suitable material known in the art. The substrate and/or superstrate may be soft, flexible, rigid, or stiff. Alternatively, the substrate and/or superstrate may include rigid and stiff segments while simultaneously including soft and flexible segments. The substrate and/or superstrate may be transparent to light, may be opaque, or may not transmit light (i.e., may be impervious to light). A superstrate may transmit light. In one example, the substrate and/or superstrate includes glass. In another example, the substrate and/or superstrate includes metal foils, polyimides, ethylene-vinyl acetate copolymers, and/or organic fluoropolymers including, but not limited to, ethylene tetrafluoroethylene (ETFE), Tedlar®, polyester/Tedlar®, Tedlar®/polyester/Tedlar®, polyethylene terephthalate (PET) alone or coated with silicon and oxygenated materials (SiOx), and combinations thereof. In one example, the substrate is further defined as a PET/SiOx-PET/Al substrate, wherein x has a value of from 1 to 4.

The substrate and/or superstrate may be load bearing or non-load bearing and may be included in any portion of the optical assembly. The substrate may be a “bottom layer” of the optical assembly that is positioned behind the optical device and serves, at least in part, as mechanical support for the optical device and the optical assembly in general. Alternatively, the optical assembly may include a second or additional substrate and/or superstrate. The substrate may be the bottom layer of the optical assembly while a second substrate may be the top layer and function as the superstrate. A second substrate (e.g., a second substrate functioning as a superstrate) may be substantially transparent to light (e.g., visible, UV, and/or infrared light) and is positioned on top of the substrate. The second substrate may be used to protect the optical assembly from environmental conditions such as rain, show, and heat. In one example, the second substrate functions as a superstrate and is a rigid glass panel that is substantially transparent to light and is used to protect the front surface of the optical assembly.

In addition, the optical assembly may also include one or more tie layers. The one or more tie layers may be disposed on the substrate to adhere the optical device to the substrate. In one example, the optical assembly does not include a substrate and does not include a tie layer. The tie layer may be transparent to UV, infrared, and/or visible light. However, the tie layer may be impermeable to light or opaque. The tie layer may be tacky and may be a gel, gum, liquid, paste, resin, or solid. In one example, the tie layer is a film.

Alternatively, the optical assembly may include the silicone-containing hot melt composition in a single layer or in multiple layers free of the release liner. In another example, the phosphor is present in a density gradient and the optical assembly includes a controlled dispersion of the phosphor. In this example, the controlled dispersion may be sedimented and/or precipitated. In still another example, the optical assembly may have a gradient of a modulus and/or of hardness in any one or more layers. In still another example, the optical assembly may include one or more gas barrier layers present in any portion of the optical assembly. It is also contemplated that the optical assembly may include one or more of a tackless layer, a non-dust layer, and/or a stain layer present in any portion of the optical assembly. The optical assembly may further include a combination of a B-stage film (e.g., an embodiment of the silicone-containing hot melt composition) and include one or more layers of a non-melting film. The optical assembly may also include one or more hard layers, e.g., glass, polycarbonate, or polyethylene terephthalate, disposed within, e.g., on top, of the optical assembly. The hard layer may be disposed as an outermost layer of the optical assembly. The optical assembly may include a first hard layer as a first outermost layer and a second hard layer as a second outermost layer. The optical assembly may further include one or more diffuser infused layers disposed in any portion of the optical assembly. The one or more diffuser layers may include, for example, e-powder, TiO₂, Al₂O₃, etc. The optical assembly may include a reflector and/or the solid composition (e.g., as a film) may include reflector walls embedded therein. Any one or more of the layers of the solid state film may be smooth, may be patterned, or may include smooth portions and patterned portions. The optical assembly may alternatively include, for example instead of a phosphor, carbon nanotubes. Alternatively, carbon nano-tubes may be aligned in a certain direction, for example on a wafer surface. A film can be cast around these carbon nanotubes to generate a transparent film with improved heat dissipation character.

### Compositions

The optical assemblies of the embodiments described herein include, among other things, an encapsulant. The encapsulant, in turn, includes a reactive or non-reactive silicone-containing hot melt composition that is made from the solid compositions described herein. In some embodiments, compositions are contemplated where resin-linear organosiloxane block copolymer compositions, such as those described herein and those described in Published PCT Appl. Nos. WO2012/040367 and WO2012/040305 (the entireties of both of which are incorporated by reference as if fully set forth herein) are combined with linear or resin organopolysiloxane components by, e.g., blending methods. Such compositions are described in U.S. Provisional Patent Appl. Ser. No. 61/613,510, filed Mar. 21, 2012. Such compositions exhibit improved toughness and flow behavior of the resin-linear organosiloxane block copolymer compositions with minimum impact, if any, on the optical transmission properties of cured films of resin-linear organosiloxane block copolymers.

As used herein, the term “resin-linear composition” includes organosiloxane block copolymer having an organosiloxane “resin” portion coupled to an organosiloxane “linear” portion. Resin-linear compositions are described in greater detail below. Resin-linear compositions also include those disclosed in U.S. Pat. No. 8,178,642, the entirety of which is incorporated by reference as if fully set forth herein. Briefly, the resin-linear compositions disclosed in the '642 patent include compositions containing: (A) a solvent-soluble organopolysiloxane resulting from the hydrosilylation reaction between an organopolysiloxane represented by the average structural formula RₐSiO_{(4-a)/2} and a diorganopolysiloxane represented by the general formula HR²₂Si(R²₂SiO)ₙR²₂SiH; and (B) an organohydrogenpolysiloxane represented by the average structural formula R²_{b}H_{c}SiO; and (C) a hydrosilylation catalyst, where the variables Rₐ, R², a, n, b, and c are defined therein.

As disclosed in detail herein, the resin-linear composition may include various characteristics. In certain resin-linear compositions, the composition includes a resin-rich phase and a phase separated linear-rich phase.

In some specific examples, resin-linear compositions contain organosiloxane block copolymers containing:
40 to 90 mole percent disiloxy units of the formula [R¹₂SiO_{2/2}],
10 to 60 mole percent trisiloxy units of the formula [R²SiO_{3/2}],
0.5 to 25 mole percent silanol groups [≡SiOH];
wherein:
   R¹ is independently a C₁ to C₃₀ hydrocarbyl,
   R² is independently a C₁ to C₂₀ hydrocarbyl;
wherein:
   the disiloxy units [R¹₂SiO_{2/2}] are arranged in linear blocks having an average of from 10 to 400 disiloxy units [R¹₂SiO_{2/2}] per linear block,
   the trisiloxy units [R²SiO_{3/2}] are arranged in non-linear blocks having a molecular weight of at least 500 g/mole, at least 30% of the non-linear blocks are crosslinked with each other and are predominately aggregated together in nano-domains, each linear block is linked to at least one non-linear block; and
the organosiloxane block copolymer has a weight average molecular weight of at least 20,000 g/mole, and is a solid at 25° C.

The organosiloxane block copolymer of the examples described herein are referred to as “resin-linear” organosiloxane block copolymers and include siloxy units independently selected from (R₃SiO_{1/2}), (R₂SiO_{2/2}), (RSiO_{3/2}), or (SiO_{4/2}) siloxy units, where R may be any organic group. These siloxy units are commonly referred to as M, D, T, and Q units respectively. These siloxy units can be combined in various manners to form cyclic, linear, or branched structures. The chemical and physical properties of the resulting polymeric structures vary depending on the number and type of siloxy units in the organopolysiloxane. For example, “linear” organopolysiloxanes typically contain mostly D, or (R₂SiO_{2/2}) siloxy units, which results in polydiorganosiloxanes that are fluids of varying viscosities, depending on the “degree of polymerization” or DP as indicated by the number of D units in the polydiorganosiloxane. “Linear” organopolysiloxanes typically have glass transition temperatures (T_{g}) that are lower than 25° C. “Resin” organopolysiloxanes result when a majority of the siloxy units are selected from T or Q siloxy units. When T siloxy units are predominately used to prepare an organopolysiloxane, the resulting organosiloxane is often referred to as a “resin” or a “silsesquioxane resin”. Increasing the amount of T or Q siloxy units in an organopolysiloxane typically results in polymers having increasing hardness and/or glass like properties. “Resin” organopolysiloxanes thus have higher T_{g} values, for example siloxane resins often have T_{g} values greater than 40° C., e.g., greater than 50° C., greater than 60° C., greater than 70° C., greater than 80° C., greater than 90° C. or greater than 100° C. In some embodiments, T_{g} for siloxane resins is from about 60° C. to about 100° C., e.g., from about 60° C. to about 80° C., from about 50° C. to about 100° C., from about 50° C. to about 80° C. or from about 70° C. to about 100° C.

As used herein “organosiloxane block copolymers” or “resin-linear organosiloxane block copolymers” refer to organopolysiloxanes containing “linear” D siloxy units in combination with “resin” T siloxy units. In some embodiments, the organosiloxane copolymers are “block” copolymers, as opposed to “random” copolymers. As such, the “resin-linear organosiloxane block copolymers” described herein refer to organopolysiloxanes containing D and T siloxy units, where the D units (i.e., [R¹₂SiO_{2/2}] units) are primarily bonded together to form polymeric chains having, in some embodiments, an average of from 10 to 400 D units (e.g., about 10 to about 400 D units; about 10 to about 300 D units; about 10 to about 200 D units; about 10 to about 100 D units; about 50 to about 400 D units; about 100 to about 400 D units; about 150 to about 400 D units; about 200 to about 400 D units; about 300 to about 400 D units; about 50 to about 300 D units; about 100 to about 300 D units; about 150 to about 300 D units; about 200 to about 300 D units; about 100 to about 150 D units, about 115 to about 125 D units, about 90 to about 170 D units or about 110 to about 140 D units), which are referred herein as “linear blocks”.

The T units (i.e., [R²SiO_{3/2}]) are primarily bonded to each other to form branched polymeric chains, which are referred to as “non-linear blocks”. In some embodiments, a significant number of these non-linear blocks may further aggregate to form “nano-domains” when solid forms of the block copolymer are provided. In some embodiments, these nano-domains form a phase separate from a phase formed from linear blocks having D units, such that a resin-rich phase forms. In some embodiments, the disiloxy units [R¹₂SiO_{2/2}] are arranged in linear blocks having an average of from 10 to 400 disiloxy units [R¹₂SiO_{2/2}] per linear block (e.g., about 10 to about 400 D units; about 10 to about 300 D units; about 10 to about 200 D units; about 10 to about 100 D units; about 50 to about 400 D units; about 100 to about 400 D units; about 150 to about 400 D units; about 200 to about 400 D units; about 300 to about 400 D units; about 50 to about 300 D units; about 100 to about 300 D units; about 150 to about 300 D units; about 200 to about 300 D units; about 100 to about 150 D units, about 115 to about 125 D units, about 90 to about 170 D units or about 110 to about 140 D units), and the trisiloxy units [R²SiO_{3/2}] are arranged in non-linear blocks having a molecular weight of at least 500 g/mole and at least 30% of the non-linear blocks are crosslinked with each other.

The aforementioned formulas may be alternatively described as [R¹₂SiO_{2/2}]ₐ[R²SiO_{3/2}]_{b} where the subscripts a and b represent the mole fractions of the siloxy units in the organosiloxane block copolymer. In these formulas, a may vary from 0.4 to 0.9, alternatively from 0.5 to 0.9, and alternatively from 0.6 to 0.9. Also in these formulas, b can vary from 0.1 to 0.6, alternatively from 0.1 to 0.5 and alternatively from 0.1 to 0.4.

R¹ in the above disiloxy unit formula is independently a C₁ to C₃₀ hydrocarbyl. The hydrocarbon group may independently be an alkyl, aryl, or alkylaryl group. As used herein, hydrocarbyl also includes halogen substituted hydrocarbyls, where the halogen may be chlorine, fluorine, bromine or combinations thereof. R¹ may be a C₁ to C₃₀ alkyl group, alternatively R¹ may be a C₁ to C₁₈ alkyl group. Alternatively R¹ may be a C₁ to C₆ alkyl group such as methyl, ethyl, propyl, butyl, pentyl, or hexyl. Alternatively R¹ may be methyl. R¹ may be an aryl group, such as phenyl, naphthyl, or an anthryl group. Alternatively, R¹ may be any combination of the aforementioned alkyl or aryl groups. Alternatively, R¹ is phenyl, methyl, or a combination of both.

Each R² in the above trisiloxy unit formula is independently a C₁ to C₂₀ hydrocarbyl. As used herein, hydrocarbyl also includes halogen substituted hydrocarbyls, where the halogen may be chlorine, fluorine, bromine or combinations thereof. R² may be an aryl group, such as phenyl, naphthyl, anthryl group. Alternatively, R² may be an alkyl group, such as methyl, ethyl, propyl, or butyl. Alternatively, R² may be any combination of the aforementioned alkyl or aryl groups. Alternatively, R² is phenyl or methyl.

The organosiloxane block copolymer may include additional siloxy units, such as M siloxy units, Q siloxy units, other unique D or T siloxy units (e.g. having a organic groups other than R¹ or R²), so long as the organosiloxane block copolymer includes the mole fractions of the disiloxy and trisiloxy units as described above. In other words, the sum of the mole fractions as designated by subscripts a and b, do not necessarily have to sum to one. The sum of a+b may be less than one to account for amounts of other siloxy units that may be present in the organosiloxane block copolymer. For example, the sum of a+b may be greater than 0.6, greater than 0.7, greater than 0.8, greater than 0.9, greater than 0.95, or greater than 0.98 or 0.99.

In one example, the organosiloxane block copolymer consists essentially of the disiloxy units of the formula R¹₂SiO_{2/2} and trisiloxy units of the formula R²SiO_{3/2}, in the aforementioned weight percentages, while also including 0.5 ₜₒ 25 mole percent silanol groups [≡SiOH], wherein R¹ and R² are as described above. Thus, in this example, the sum of a+b (when using mole fractions to represent the amount of disiloxy and trisiloxy units in the copolymer) is greater than 0.95, alternatively greater than 0.98. Moreover, in this example, the terminology “consisting essentially of” describes that the organosiloxane block copolymer is free of other siloxane units not described herein.

The formula [R¹₂SiO_{2/2}]ₐ[R²SiO_{3/2}]_{b}, and related formulae using mole fractions, as described herein, do not limit the structural ordering of the disiloxy R¹₂SiO_{2/2} and trisiloxy R²SiO_{3/2} units in the organosiloxane block copolymer. Rather, these formulae provide a non-limiting notation to describe the relative amounts of the two units in the organosiloxane block copolymer, as per the mole fractions described above via the subscripts a and b. The mole fractions of the various siloxy units in the organosiloxane block copolymer, as well as the silanol content, may be determined by ²⁹Si NMR techniques.

In some embodiments, the organosiloxane block copolymers described herein comprise 40 to 90 mole percent disiloxy units of the formula [R¹₂SiO_{2/2}], e.g., 50 to 90 mole percent disiloxy units of the formula [R¹₂SiO_{2/2}]; 60 to 90 mole percent disiloxy units of the formula [R¹₂SiO_{2/2}]; 65 to 90 mole percent disiloxy units of the formula [R¹₂SiO_{2/2}]; 70 to 90 mole percent disiloxy units of the formula [R¹₂SiO_{2/2}]; or 80 to 90 mole percent disiloxy units of the formula [R¹₂SiO_{2/2}]; 40 to 80 mole percent disiloxy units of the formula [R¹₂SiO_{2/2}]; 40 to 70 mole percent disiloxy units of the formula [R¹₂SiO_{2/2}]; 40 to 60 mole percent disiloxy units of the formula [R¹₂SiO_{2/2}]; 40 to 50 mole percent disiloxy units of the formula [R¹₂SiO_{2/2}]; 50 to 80 mole percent disiloxy units of the formula [R¹₂SiO_{2/2}]; 50 to 70 mole percent disiloxy units of the formula [R¹₂SiO_{2/2}]; 50 to 60 mole percent disiloxy units of the formula [R¹₂SiO_{2/2}]; 60 to 80 mole percent disiloxy units of the formula [R¹₂SiO_{2/2}]; 60 to 70 mole percent disiloxy units of the formula [R¹₂SiO_{2/2}]; or 70 to 80 mole percent disiloxy units of the formula [R¹₂SiO_{2/2}].

In some embodiments, the organosiloxane block copolymers described herein comprise 10 to 60 mole percent trisiloxy units of the formula [R²SiO_{3/2}], e.g., 10 to 20 mole percent trisiloxy units of the formula [R²SiO_{3/2}]; 10 to 30 mole percent trisiloxy units of the formula [R²SiO_{3/2}]; 10 to 35 mole percent trisiloxy units of the formula [R²SiO_{3/2}]; 10 to 40 mole percent trisiloxy units of the formula [R²SiO_{3/2}]; 10 to 50 mole percent trisiloxy units of the formula [R²SiO_{3/2}]; 20 to 30 mole percent trisiloxy units of the formula [R²SiO_{3/2}]; 20 to 35 mole percent trisiloxy units of the formula [R²SiO_{3/2}]; 20 to 40 mole percent trisiloxy units of the formula [R²SiO_{3/2}]; 20 to 50 mole percent trisiloxy units of the formula [R²SiO_{3/2}]; 20 to 60 mole percent trisiloxy units of the formula [R²SiO_{3/2}]; 30 to 40 mole percent trisiloxy units of the formula [R²SiO_{3/2}]; 30 to 50 mole percent trisiloxy units of the formula [R²SiO_{3/2}]; 30 to 60 mole percent trisiloxy units of the formula [R²SiO_{3/2}]; 40 to 50 mole percent trisiloxy units of the formula [R²SiO_{3/2}]; or 40 to 60 mole percent trisiloxy units of the formula [R²SiO_{3/2}].

In some embodiments, the organosiloxane block copolymers described herein comprise 0.5 to 25 mole percent silanol groups [≡SiOH] (e.g., 0.5 to 5 mole percent, 0.5 to 10 mole percent, 0.5 to 15 mole percent, 0.5 to 20 mole percent, 5 to 10 mole percent, 5 to 15 mole percent, 5 to 20 mole percent, 5 to 25 mole percent, 10 to 15 mole percent 10 to 20 mole percent, 10 to 25 mole percent, 15 to 20 mole percent, 15 to 25 mole percent, or 20 to 25 mole percent). The silanol groups present on the resin component of the organosiloxane block copolymer may allow the organosiloxane block copolymer to further react or cure at elevated temperatures or to cross-link. The crosslinking of the non-linear blocks may be accomplished via a variety of chemical mechanisms and/or moieties. For example, crosslinking of non-linear blocks within the organosiloxane block copolymer may result from the condensation of residual silanol groups present in the non-linear blocks of the organosiloxane block copolymer.

In some embodiments, the disiloxy units [R¹₂SiO_{2/2}] in the organosiloxane block copolymers described herein are arranged in linear blocks having an average of 10 to 400 disiloxy units, e.g., about 10 to about 400 disiloxy units; about 10 to about 300 disiloxy units; about 10 to about 200 disiloxy units; about 10 to about 100 disiloxy units; about 50 to about 400 disiloxy units; about 100 to about 400 disiloxy units; about 150 to about 400 disiloxy units; about 200 to about 400 disiloxy units; about 300 to about 400 disiloxy units; about 50 to about 300 disiloxy units; about 100 to about 300 disiloxy units; about 150 to about 300 disiloxy units; about 200 to about 300 disiloxy units; about 100 to about 150 disiloxy units, about 115 to about 125 disiloxy units, about 90 to about 170 disiloxy units or about 110 to about 140 disiloxy units).

In some embodiments, the non-linear blocks in the organosiloxane block copolymers described herein have a number average molecular weight of at least 500 g/mole, e.g., at least 1000 g/mole, at least 2000 g/mole, at least 3000 g/mole or at least 4000 g/mole; or have a molecular weight of from about 500 g/mole to about 4000 g/mole, from about 500 g/mole to about 3000 g/mole, from about 500 g/mole to about 2000 g/mole, from about 500 g/mole to about 1000 g/mole, from about 1000 g/mole to 2000 g/mole, from about 1000 g/mole to about 1500 g/mole, from about 1000 g/mole to about 1200 g/mole, from about 1000 g/mole to 3000 g/mole, from about 1000 g/mole to about 2500 g/mole, from about 1000 g/mole to about 4000 g/mole, from about 2000 g/mole to about 3000 g/mole or from about 2000 g/mole to about 4000 g/mole.

In some embodiments, at least 30% of the non-linear blocks in the organosiloxane block copolymers described herein are crosslinked with each other, e.g., at least 40% of the non-linear blocks are crosslinked with each other; at least 50% of the non-linear blocks are crosslinked with each other; at least 60% of the non-linear blocks are crosslinked with each other; at least 70% of the non-linear blocks are crosslinked with each other; or at least 80% of the non-linear blocks are crosslinked with each other. In other embodiments, from about 30% to about 80% of the non-linear blocks are crosslinked with each other; from about 30% to about 70% of the non-linear blocks are crosslinked with each other; from about 30% to about 60% of the non-linear blocks are crosslinked with each other; from about 30% to about 50% of the non-linear blocks are crosslinked with each other; from about 30% to about 40% of the non-linear blocks are crosslinked with each other; from about 40% to about 80% of the non-linear blocks are crosslinked with each other; from about 40% to about 70% of the non-linear blocks are crosslinked with each other; from about 40% to about 60% of the non-linear blocks are crosslinked with each other; from about 40% to about 50% of the non-linear blocks are crosslinked with each other; from about 50% to about 80% of the non-linear blocks are crosslinked with each other; from about 50% to about 70% of the non-linear blocks are crosslinked with each other; from about 55% to about 70% of the non-linear blocks are crosslinked with each other; from about 50% to about 60% of the non-linear blocks are crosslinked with each other; from about 60% to about 80% of the non-linear blocks are crosslinked with each other; or from about 60% to about 70% of the non-linear blocks are crosslinked with each other.

In some embodiments, the organosiloxane block copolymers described herein have a weight average molecular weight (M_{w}) of at least 20,000 g/mole, alternatively a weight average molecular weight of at least 40,000 g/mole, alternatively a weight average molecular weight of at least 50,000 g/mole, alternatively a weight average molecular weight of at least 60,000 g/mole, alternatively a weight average molecular weight of at least 70,000 g/mole, or alternatively a weight average molecular weight of at least 80,000 g/mole. In some embodiments, the organosiloxane block copolymers described herein have a weight average molecular weight (M_{w}) of from about 20,000 g/mole to about 250,000 g/mole or from about 100,000 g/mole to about 250,000 g/mole, alternatively a weight average molecular weight of from about 40,000 g/mole to about 100,000 g/mole, alternatively a weight average molecular weight of from about 50,000 g/mole to about 100,000 g/mole, alternatively a weight average molecular weight of from about 50,000 g/mole to about 80,000 g/mole, alternatively a weight average molecular weight of from about 50,000 g/mole to about 70,000 g/mole, alternatively a weight average molecular weight of from about 50,000 g/mole to about 60,000 g/mole. In other embodiments, the weight average molecular weight of the organosiloxane block copolymers described herein is from 40,000 to 100,000, from 50,000 to 90,000, from 60,000 to 80,000, from 60,000 to 70,000, of from 100,000 to 500,000, of from 150,000 to 450,000, of from 200,000 to 400,000, of from 250,000 to 350,000, or from 250,000 to 300,000, g/mol. In still other embodiments, the organosiloxane block copolymer has a weight average molecular weight of from 40,000 to 60,000, from 45,000 to 55,000, or about 50,000, g/mol.

In some embodiments, the organosiloxane block copolymers described herein have a number average molecular weight (Mₙ) of from about 15,000 to about 50,000 g/mole; from about 15,000 to about 30,000 g/mole; from about 20,000 to about 30,000 g/mole; or from about 20,000 to about 25,000 g/mole.

In some embodiments, the aforementioned organosiloxane block copolymers are isolated in a solid form, for example by casting films of a solution of the block copolymer in an organic solvent (e.g., benzene, toluene, xylene or combinations thereof) and allowing the solvent to evaporate. Under these conditions, the aforementioned organosiloxane block copolymers can be provided as solutions in an organic solvent containing from about 50 wt % to about 80 wt % solids, e.g., from about 60 wt % to about 80 wt %, from about 70 wt % to about 80 wt % or from about 75 wt % to about 80 wt % solids. In some embodiments, the solvent is toluene. In some embodiments, such solutions will have a viscosity of from about 1500 cSt to about 4000 cSt at 25° C., e.g., from about 1500 cSt to about 3000 cSt, from about 2000 cSt to about 4000 cSt or from about 2000 cSt to about 3000 cSt at 25° C.

Upon drying or forming a solid, the non-linear blocks of the block copolymer further aggregate together to form “nano-domains”. As used herein, “predominately aggregated” means the majority of the non-linear blocks of the organosiloxane block copolymer are found in certain regions of the solid composition, described herein as “nano-domains”. As used herein, “nano-domains” refers to those phase regions within the solid block copolymer compositions that are phase separated within the solid block copolymer compositions and possess at least one dimension sized from 1 to 100 nanometers. The nano-domains may vary in shape, providing at least one dimension of the nano-domain is sized from 1 to 100 nanometers. Thus, the nano-domains may be regular or irregularly shaped. The nano-domains may be spherically shaped, tubular shaped, and in some instances lamellar shaped.

In a further embodiment, the solid organosiloxane block copolymers as described above contain a first phase and an incompatible second phase, the first phase containing predominately the disiloxy units [R¹₂SiO_{2/2}] as defined above, the second phase containing predominately the trisiloxy units [R²SiO_{3/2}] as defined above, the non-linear blocks being sufficiently aggregated into nano-domains which are incompatible with the first phase.

When solid compositions are formed from curable compositions of the organosiloxane block copolymers described herein, which, in some embodiments also contain an organosiloxane resin (e.g., free resin that is not part of the block copolymer), the organosiloxane resin also predominately aggregates within the nano-domains. In one example, the solid composition may be a pellet, spheroid, ribbon, sheet, cube, powder (e.g., a powder having an average particle size of not more than 500 μm, including a powder having an average particle size of from about 5 to about 500 μm; from about 10 to about 100 μm; from about 10 to about 50 μm ; from about 30 to about 100 μm; from about 50 to about 100 μm; from about 50 to about 250 μm; from about 100 to about 500 μm; from about 150 to about 300 μm; or from about 250 to about 500 μm), flake, etc. The dimensions of the solid composition are not particularly limited.

The structural ordering of the disiloxy and trisiloxy units in the solid block copolymers of the present disclosure, and characterization of the nano-domains, may be determined explicitly using certain analytical techniques such as Transmission Electron Microscopic (TEM) techniques, Atomic Force Microscopy (AFM), Small Angle Neutron Scattering, Small Angle X-Ray Scattering, and Scanning Electron Microscopy.

Alternatively, the structural ordering of the disiloxy and trisiloxy units in the block copolymer, and formation of nano-domains, may be implied by characterizing certain physical properties of coatings resulting from the present organosiloxane block copolymers. For example, the present organosiloxane copolymers may provide coatings that have an optical transmittance of visible light greater than 95%. One skilled in the art recognizes that such optical clarity is possible (other than refractive index matching of the two phases) only when visible light is able to pass through such a medium and not be diffracted by particles (or domains as used herein) having a size greater than 150 nanometers. As the particle size, or domains further decreases, the optical clarity may be further improved. Thus, coatings derived from the present organosiloxane copolymers may have an optical transmittance of visible light of at least 95%, e.g., at least 96%; at least 97%; at least 98%; at least 99%; or 100% transmittance of visible light. As used herein, the term “visible light” includes light with wavelengths above 350 nm.

The solid composition of this disclosure may include phase separated “soft” and “hard” segments resulting from blocks of linear D units and aggregates of blocks of non-linear T units, respectively. These respective soft and hard segments may be determined or inferred by differing glass transition temperatures (T_{g}). Thus a linear segment may be described as a “soft” segment typically having a low T_{g} , for example less than 25° C., alternatively less than 0° C., or alternatively even less than −20° C. The linear segments typically maintain “fluid” like behavior in a variety of conditions. Conversely, non-linear blocks may be described as “hard segments” having higher T_{g} , values, for example greater than 30° C., alternatively greater than 40° C. , or alternatively even greater than 50° C.

One advantage of the present resin-linear organopolysiloxanes block copolymers is that they can be processed several times, because the processing temperature (T_{processing}) is less than the temperature required to finally cure (T_{cure}) the organosiloxane block copolymer, i.e., T_{processing}<T_{cure}. However the organosiloxane copolymer will cure and achieve high temperature stability when T_{processing} is taken above T_{cure}. Thus, the present resin-linear organopolysiloxanes block copolymers offer the significant advantage of being “re-processable” in conjunction with the benefits typically associated with silicones, such as; hydrophobicity, high temperature stability, moisture/UV resistance.

In one embodiment, a linear soft block siloxane unit, e.g., with a degree of polymerization (dp)>2 (e.g., dp>10; dp>50; dp>100; dp>150; or dp from about 2 to about 150; dp from about 50 to about 150; or dp from about 70 to about 150) is grafted to a linear or resinous “hard block” siloxane unit with a glass transition above room temperature. In a related embodiment, the organosiloxane block copolymer (e.g., silanol terminated organosiloxane block copolymer) is reacted with a silane, such as methyl triacetoxy silane and/or methyl trioxime silane, followed by reaction with a silanol functional phenyl silsesquioxane resin. In still other embodiments, the organosiloxane block copolymer includes one or more soft blocks (e.g., blocks with glass transition<25° C.) and one or more linear siloxane “pre-polymer” blocks that, in some embodiments, include aryl groups as side chains (e.g., poly(phenyl methyl siloxane). In another embodiment, the organosiloxane block copolymer includes PhMe-D contents >20 mole % (e.g., >30 mole %; >40 mole %; >50 mole %; or from about 20 to about 50 mole %; about 30 to about 50 mole %; or from about 20 to about 30 mole %); PhMe-D dp>2 (e.g., dp>10; dp>50; dp>100; dp>150; or dp from about 2 to about 150; dp from about 50 to about 150; or dp from about 70 to about 150); and/or Ph₂-D/Me₂>20 mole % (e.g., >30 mole %; >40 mole %; >50 mole %; or from about 20 to about 50 mole %; about 30 to about 50 mole %; or from about 20 to about 30 mole %), where the mole ratio of Ph₂-D/Me₂-D is about 3/7. In some embodiments, the Ph₂-D/Me₂-D mole ratio is from about 1/4 to about 1/2, e.g., about 3/7 to about 3/8. In still other embodiments, the organosiloxane block copolymer includes one or more hard blocks (e.g., blocks with glass transition >25° C.) and one or more linear or resinous siloxanes, for example, phenyl silsesquioxane resins, which may be used to form non-tacky films.

In some embodiments, the solid compositions, which include a resin-linear organosiloxane block copolymer, also contain a superbase catalyst. See, e.g., PCT Appl. No. PCT/US2012/069701, filed Dec. 14, 2012; and U.S. Provisional Appl. No. 61/570,477, filed Dec. 14, 2012, the entireties of which are incorporated by reference as if fully set forth herein. The term “superbase” and “superbase catalyst” are used herein interchangeably. In some embodiments, solid compositions comprising a superbase catalyst exhibit enhanced cure rates, improved mechanical strength, and improved thermal stability over similar compositions without the superbase catalyst.

In some embodiments, the solid compositions, which include a resin-linear organosiloxane block copolymer, also contain a stabilizer. See, e.g., PCT Appl. No. PCT/US2012/067334, filed Nov. 30, 2012; and U.S. Provisional Appl. No. 61/566,031, filed Dec. 2, 2011, the entireties of which are incorporated by reference as if fully set forth herein. A stabilizer is added to the resin-linear organosiloxane block copolymers, as described above, to improve shelf stability and/or other physical properties of solid compositions containing the organosiloxane block copolymers. The stabilizer may be selected from an alkaline earth metal salt, a metal chelate, a boron compound, a silicon-containing small molecule or combinations thereof.

### Method of Forming The Solid Composition:

The solid composition of this invention may be formed by a method that includes the step of reacting one or more resins, such as Phenyl-T resins, with one or more (silanol) terminated siloxanes, such as PhMe siloxanes. Alternatively, one or more resins may be reacted with one or more capped siloxane resins, such as silanol terminated siloxanes capped with MTA/ETA, MTO, ETS 900, and the like. In another example, the solid composition is formed by reacting one or more components described above and/or one or more components described in U.S. Prov. Patent Appl. Ser. Nos. 61/385,446, filed Sep. 22, 2010; 61/537,146, filed Sep. 21, 2011; 61/537,151, filed Sep. 21, 2011; and 61/537,756, filed Sep. 22, 2011; and/or described in Published PCT Appl. Nos. WO2012/040302; WO2012/040305; WO2012/040367; WO2012/040453; and WO2012/040457, all of which are expressly incorporated herein by reference. In still another example, the method may include one or more steps described any of the aforementioned applications.

Alternatively, the method may include the step of providing the composition in a solvent, e.g., a curable silicone composition that includes a solvent, and then removing the solvent to form the solid composition. The solvent may be removed by any known processing techniques. In one example, a film including the organosiloxane block copolymer is formed and the solvent is allowed to evaporate from a curable silicone composition thereby forming a film. Subjecting the films to elevated temperatures, and/or reduced pressures, will accelerate solvent removal and subsequent formation of the solid composition. Alternatively, a curable silicone composition may be passed through an extruder to remove solvent and provide a solid composition in the form of a ribbon or pellets. Coating operations against a release film can also be used as in slot die coating, knife over roll coating, rod coating, or gravure coating. Also, roll-to-roll coating operations can be used to prepare a solid film. In coating operations, a conveyer oven or other means of heating and evacuating the solution can be used to drive off the solvent and obtain a solid composition.

### Method of Forming the Organosiloxane Block Copolymer:

The organosiloxane block copolymer may be formed using a method that includes the step of I) reacting a) a linear organosiloxane and b) an organosiloxane resin comprising at least 60 mol % of [R²SiO_{3/2}] siloxy units in its formula, in c) a solvent. In one example, the linear organosiloxane has the formula R¹_{q}(E)_{(3-q)}SiO(R¹₂SiO_{2/2})ₙSi(E)_{(3-q)} R¹_{q}, wherein each R¹ is independently a C₁ to C₃₀ hydrocarbyl, n is 10 to 400, q is 0, 1, or 2, E is a hydrolyzable group including at least one carbon atom. In another example, each R² is independently a C₁ to C₂₀ hydrocarbyl. In still another example, the amounts of a) and b) used in step I are selected to provide the organosiloxane block copolymer with 40 to 90 mol % of disiloxy units [R¹₂SiO_{2/2}] and 10 to 60 mol % of trisiloxy units [R²SiO_{3/2}]. In an even further example, at least 95 weight percent of the linear organosiloxane added in step I is incorporated into the organosiloxane block copolymer.

In still another example, the method includes step of II) reacting the organosiloxane block copolymer from step I), e.g., to crosslink the trisiloxy units of the organosiloxane block copolymer and/or to increase the weight average molecular weight (M_{w}) of the organosiloxane block copolymer by at least 50%. A further example includes the step of further processing the organosiloxane block copolymer to enhance storage stability and/or optical clarity and/or the optional step of removing the organic solvent.

The reaction of the first step may be represented generally according to the following schematic:

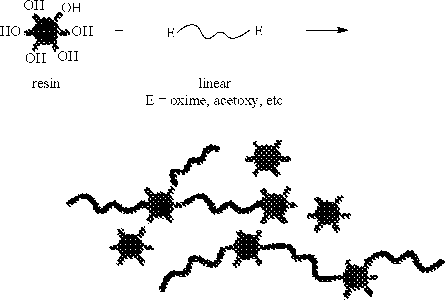 [SMILES: O ; O ; O ; O ; O ; O]

wherein various OH groups (i.e., SiOH groups) on the organosiloxane resin may be reacted with the hydrolyzable groups (E) on the linear organosiloxane, to form the organosiloxane block copolymer and an H-(E) compound. The reaction in step I may be described as a condensation reaction between the organosiloxane resin and the linear organosiloxane.

### The (a) Linear Orqanosiloxane:

Component a) in step I of the present process is a linear organosiloxane having the formula R¹_{q}(E)_{(3-q)}SiO(R¹₂SiO_{2/2})ₙSi(E)_{(3-q)}R¹_{q}, where each R¹ is independently a C₁ to C₃₀ hydrocarbyl, the subscript “n” may be considered as the degree of polymerization (dp) of the linear organosiloxane and may vary from 10 to 400, the subscript “q” may be 0, 1, or 2, and E is a hydrolyzable group containing at least one carbon atom. While component a) is described as a linear organosiloxane having the formula R¹_{q}(E)_{(3-q)}SiO(R¹₂SiO_{2/2})ₙSi(E)_{(3-q)}R¹_{q}, one skilled in the art recognizes small amount of alternative siloxy units, such a T (R¹SiO_{3/2}) siloxy units, may be incorporated into the linear organosiloxane and still be used as component a). As such, the organosiloxane may be considered as being “predominately” linear by having a majority of D (R¹₂SiO_{2/2}) siloxy units. Furthermore, the linear organosiloxane used as component a) may be a combination of several linear organosiloxanes. Still further, the linear organosiloxane used as component a) may comprise silanol groups. In some embodiments, the linear organosiloxane used as component a) comprises from about 0.5 to about 5 mole % silanol groups, e.g., from about 1 mole % to about 3 mole %; from about 1 mole % to about 2 mole % or from about 1 mole % to about 1.5 mole % silanol groups.

R¹ in the above linear organosiloxane formula is independently a C₁ to C₃₀ hydrocarbyl. The hydrocarbon group may independently be an alkyl, aryl, or alkylaryl group. As used herein, hydrocarbyl also includes halogen substituted hydrocarbyls, where the halogen may be chlorine, fluorine, bromine or combinations thereof. R¹ may be a C₁ to 0₃₀ alkyl group, alternatively R¹ may be a C₁ to 0₁₈ alkyl group. Alternatively R¹ may be a C₁ to C₆ alkyl group such as methyl, ethyl, propyl, butyl, pentyl, or hexyl. Alternatively R¹ may be methyl. R¹ may be an aryl group, such as phenyl, naphthyl, or an anthryl group. Alternatively, R¹ may be any combination of the aforementioned alkyl or aryl groups. Alternatively, R¹ is phenyl, methyl, or a combination of both.

E may be selected from any hydrolyzable group containing at least one carbon atom. In some embodiments, E is selected from an oximo, epoxy, carboxy, amino, amido group or combinations thereof. Alternatively, E may have the formula R¹C(═O)O—, R¹₂C═N—O—, or R⁴C═N—O—, where R¹ is as defined above, and R⁴ is hydrocarbyl. In one example, E is H₃CC(═O)O— (acetoxy) and q is 1. In one example, E is (CH₃)(CH₃CH₂)C═N—O— (methylethylketoxy) and q is 1.

In one example, the linear organosiloxane has the formula (CH₃)_{q}(E)_{(3-q)}SiO[(CH₃)₂SiO_{2/2})]ₙSi(E)_{(3-q)}(CH₃)_{q}, where E, n, and q are as defined above.

In one example, the linear organosiloxane has the formula (CH₃)_{q}(E)_{(3-q)}SiO[(CH₃)(C₆H₅)SiO_{2/2})]ₙSi(E)_{(3-q)}(CH₃)_{q}, where E, n, and q are as defined above.

Processes for preparing linear organosiloxanes suitable as component a) are known. In some embodiments, a silanol terminated polydiorganosiloxane is reacted with an “endblocking” compound such as an alkyltriacetoxysilane or a dialkylketoxime. The stoichiometry of the endblocking reaction is typically adjusted such that a sufficient amount of the endblocking compound is added to react with all the silanol groups on the polydiorganosiloxane. Typically, a mole of the endblocking compound is used per mole of silanol on the polydiorganosiloxane. Alternatively, a slight molar excess such as 1 to 10% of the endblocking compound may be used. The reaction is typically conducted under anhydrous conditions to minimize condensation reactions of the silanol polydiorganosiloxane. Typically, the silanol ended polydiorganosiloxane and the endblocking compound are dissolved in an organic solvent under anhydrous conditions, and allowed to react at room temperature, or at elevated temperatures (e.g., up to the boiling point of the solvent).

### The (b) Organosiloxane Resin:

Component b) in the present process is an organosiloxane resin comprising at least 60 mole % of [R²SiO_{3/2}] siloxy units in its formula, where each R² is independently a C₁ to C₂₀ hydrocarbyl. As used herein, hydrocarbyl also includes halogen substituted hydrocarbyls, where the halogen may be chlorine, fluorine, bromine or combinations thereof. R² may be an aryl group, such as phenyl, naphthyl, anthryl group. Alternatively, R² may be an alkyl group, such as methyl, ethyl, propyl, or butyl. Alternatively, R² may be any combination of the aforementioned alkyl or aryl groups. Alternatively, R² is phenyl or methyl.

The organosiloxane resin may contain any amount and combination of other M, D, and Q siloxy units, provided the organosiloxane resin contains at least 70 mole % of [R²SiO_{3/2}] siloxy units, alternatively the organosiloxane resin contains at least 80 mole % of [R²SiO_{3/2}] siloxy units, alternatively the organosiloxane resin contains at least 90 mole % of [R²SiO_{3/2}] siloxy units, or alternatively the organosiloxane resin contains at least 95 mole % of [R²SiO_{3/2}] siloxy units. In some embodiments, the organosiloxane resin contains from about 70 to about 100 mole % of [R²SiO_{3/2}] siloxy units, e.g., from about 70 to about 95 mole % of [R²SiO_{3/2}] siloxy units, from about 80 to about 95 mole % of [R²SiO_{3/2}] siloxy units or from about 90 to about 95 mole % of [R²SiO_{3/2}] siloxy units. Organosiloxane resins useful as component b) include those known as “silsesquioxane” resins.

The weight average molecular weight (M_{w}) of the organosiloxane resin is not limiting, but, in some embodiments, ranges from 1000 to 10,000, or alternatively 1500 to 5000 g/mole.

One skilled in the art recognizes that organosiloxane resins containing such high amounts of [R²SiO_{3/2}] siloxy units will inherently have a certain concentration of Si—OZ where Z may be hydrogen (i.e., silanol), an alkyl group (so that OZ is an alkoxy group), or alternatively OZ may also be any of the “E” hydrolyzable groups as described above. The Si-OZ content as a mole percentage of all siloxy groups present on the organosiloxane resin may be readily determined by ²⁹Si NMR. The concentration of the OZ groups present on the organosiloxane resin will vary, as dependent on the mode of preparation, and subsequent treatment of the resin. In some embodiments, the silanol (Si-OH) content of organosiloxane resins suitable for use in the present process will have a silanol content of at least 5 mole %, alternatively of at least 10 mole %, alternatively 25 mole %, alternatively 40 mole %, or alternatively 50 mole %. In other embodiments, the silanol content is from about 5 mole % to about 60 mole %, e.g., from about 10 mole % to about 60 mole %, from about 25 mole % to about 60 mole %, from about 40 mole % to about 60 mole %, from about 25 mole % to about 40 mole % or from about 25 mole % to about 50 mole %.

Organosiloxane resins containing at least 60 mole % of [R²SiO_{3/2}] siloxy units, and methods for preparing them, are known in the art. They are typically prepared by hydrolyzing an organosilane having three hydrolyzable groups on the silicon atom, such as a halogen or alkoxy group in an organic solvent. A representative example for the preparation of a silsesquioxane resin may be found in U.S. Pat. No. 5,075,103. Furthermore, many organosiloxane resins are available commercially and sold either as a solid (flake or powder), or dissolved in an organic solvent. Suitable, non-limiting, commercially available organosiloxane resins useful as component b) include; Dow Corning® 217 Flake Resin, 233 Flake, 220 Flake, 249 Flake, 255 Flake, Z-6018 Flake (Dow Corning Corporation, Midland Mich.).

One skilled in the art further recognizes that organosiloxane resins containing such high amounts of [R²SiO_{3/2}] siloxy units and silanol contents may also retain water molecules, especially in high humidity conditions. Thus, it is often beneficial to remove excess water present on the resin by “drying” the organosiloxane resin prior to reacting in step I. This may be achieved by dissolving the organosiloxane resin in an organic solvent, heating to reflux, and removing water by separation techniques (for example Dean Stark trap or equivalent process).

The amounts of a) and b) used in the reaction of step I are selected to provide the resin-linear organosiloxane block copolymer with 40 to 90 mole % of disiloxy units [R¹₂SiO_{2/2}] and 10 to 60 mole % of trisiloxy units [R²SiO_{3/2}]. The mole % of dilsiloxy and trisiloxy units present in components a) and b) may be readily determined using ²⁹Si NMR techniques. The starting mole % then determines the mass amounts of components a) and b) used in step I.

In some embodiments, the organosiloxane block copolymers comprise 40 to 90 mole percent disiloxy units of the formula [R¹₂SiO_{2/2}], e.g., 50 to 90 mole percent disiloxy units of the formula [R¹₂SiO_{2/2}]; 60 to 90 mole percent disiloxy units of the formula [R¹₂SiO_{2/2}]; 65 to 90 mole percent disiloxy units of the formula [R¹₂SiO_{2/2}]; 70 to 90 mole percent disiloxy units of the formula [R¹₂SiO_{2/2}]; or 80 to 90 mole percent disiloxy units of the formula [R¹₂SiO_{2/2}]; 40 to 80 mole percent disiloxy units of the formula [R¹₂SiO_{2/2}]; 40 to 70 mole percent disiloxy units of the formula [R¹₂SiO_{2/2}]; 40 to 60 mole percent disiloxy units of the formula [R¹₂SiO_{2/2}]; 40 to 50 mole percent disiloxy units of the formula [R¹₂SiO_{2/2}]; 50 to 80 mole percent disiloxy units of the formula [R¹₂SiO_{2/2}]; 50 to 70 mole percent disiloxy units of the formula [R¹₂SiO_{2/2}]; 50 to 60 mole percent disiloxy units of the formula [R¹₂SiO_{2/2}]; 60 to 80 mole percent disiloxy units of the formula [R¹₂SiO_{2/2}]; 60 to 70 mole percent disiloxy units of the formula [R¹₂SiO_{2/2}]; or 70 to 80 mole percent disiloxy units of the formula [R¹₂SiO_{2/2}].

In some embodiments, the organosiloxane block copolymers comprise 10 to 60 mole percent trisiloxy units of the formula [R²SiO_{3/2}], e.g., 10 to 20 mole percent trisiloxy units of the formula [R²SiO_{3/2}]; 10 to 30 mole percent trisiloxy units of the formula [R²SiO_{3/2}]; 10 to 35 mole percent trisiloxy units of the formula [R²SiO_{3/2}]; 10 to 40 mole percent trisiloxy units of the formula [R²SiO_{3/2}]; 10 to 50 mole percent trisiloxy units of the formula [R²SiO_{3/2}]; 20 to 30 mole percent trisiloxy units of the formula [R²SiO_{3/2}]; 20 to 35 mole percent trisiloxy units of the formula [R²SiO_{3/2}]; 20 to 40 mole percent trisiloxy units of the formula [R²SiO_{3/2}]; 20 to 50 mole percent trisiloxy units of the formula [R²SiO_{3/2}]; 20 to 60 mole percent trisiloxy units of the formula [R²SiO_{3/2}]; 30 to 40 mole percent trisiloxy units of the formula [R²SiO_{3/2}]; 30 to 50 mole percent trisiloxy units of the formula [R²SiO_{3/2}]; 30 to 60 mole percent trisiloxy units of the formula [R²SiO_{3/2}]; 40 to 50 mole percent trisiloxy units of the formula [R²SiO_{3/2}]; or 40 to 60 mole percent trisiloxy units of the formula [R²SiO_{3/2}].

The amount of components a) and b) selected should also ensure there is a molar excess of the silanol groups on the organosiloxane resin vs. amount of linear organosiloxane added. Thus, a sufficient amount of the organosiloxane resin should be added to potentially react with all the linear organosiloxane added in step I). As such, a molar excess of the organosiloxane resin is used. The amounts used may be determined by accounting for the moles of the organosiloxane resin used per mole of the linear organosiloxane.

As discussed above, the reaction affected in step I is a condensation reaction between the hydrolyzable groups of linear organosiloxane with the silanol groups on the organosiloxane resin. A sufficient amount of silanol groups needs to remain on the resin component of the formed resin-linear organosiloxane copolymer to further react in step II of the present process. In some embodiments, at least 10 mole %, alternatively at least 20 mole %, or alternatively at least 30 mole % silanol should remain on the trisiloxy units of the resin-linear organosiloxane copolymer as produced in step I of the present process. In some embodiments, from about 10 mole % to about 60 mole %, e.g., from about 20 mole % to about 60 mole %, or from about 30 mole % to about 60 mole %, should remain on the trisiloxy units of the resin-linear organosiloxane copolymer as produced in step I of the present process.

The reaction conditions for reacting the aforementioned (a) linear organosiloxane with the (b) organosiloxane resin are not limited. In some embodiments, reaction conditions are selected to effect a condensation type reaction between the a) linear organosiloxane and b) organosiloxane resin. Various non-limiting embodiments and reaction conditions are described in the Examples below. In some embodiments, the (a) linear organosiloxane and the (b) organosiloxane resin are reacted at room temperature. In other embodiments, (a) and (b) are reacted at temperatures that exceed room temperature and that range up to about 50, 75, 100, or even up to 150° C. Alternatively, (a) and (b) can be reacted together at reflux of the solvent. In still other embodiments, (a) and (b) are reacted at temperatures that are below room temperature by 5, 10, or even more than 10° C. In still other embodiments (a) and (b) react for times of 1, 5, 10, 30, 60, 120, or 180 minutes, or even longer. Typically, (a) and (b) are reacted under an inert atmosphere, such as nitrogen or a noble gas. Alternatively, (a) and (b) may be reacted under an atmosphere that includes some water vapor and/or oxygen. Moreover, (a) and (b) may be reacted in any size vessel and using any equipment including mixers, vortexers, stirrers, heaters, etc. In other embodiments, (a) and (b) are reacted in one or more organic solvents which may be polar or non-polar. Typically, aromatic solvents such as toluene, xylene, benzene, and the like are utilized. The amount of the organosiloxane resin dissolved in the organic solvent may vary, but typically the amount should be selected to minimize the chain extension of the linear organosiloxane or pre-mature condensation of the organosiloxane resin.

The order of addition of components a) and b) may vary. In some embodiments, the linear organosiloxane is added to a solution of the organosiloxane resin dissolved in the organic solvent. This order of addition is believed to enhance the condensation of the hydrolyzable groups on the linear organosiloxane with the silanol groups on organosiloxane resin, while minimizing chain extension of the linear organosiloxane or pre-mature condensation of the organosiloxane resin. In other embodiments, the organosiloxane resin is added to a solution of the linear organosiloxane dissolved in the organic solvent.

The progress of the reaction in step I, and the formation of the resin-linear organosiloxane block copolymer, may be monitored by various analytical techniques, such as GPC, IR, or ²⁹Si NMR. Typically, the reaction in step I is allowed to continue until at least 95 weight percent (e.g., at least 96%, at least 97%, at least 98%, at least 99% or 100%) of the linear organosiloxane added in step I is incorporated into the resin-linear organosiloxane block copolymer.

The second step of the present process involves further reacting the resin-linear organosiloxane block copolymer from step I) to crosslink the trisiloxy units of the resin-linear organosiloxane block copolymer to increase the molecular weight of the resin-linear organosiloxane block copolymer by at least 50%, alternatively by at least 60%, alternatively by 70%, alternatively by at least 80%, alternatively by at least 90%, or alternatively by at least 100%. In some embodiments, the second step of the present process involves further reacting the resin-linear organosiloxane block copolymer from step I) to crosslink the trisiloxy units of the resin-linear organosiloxane block copolymer to increase the molecular weight of the resin-linear organosiloxane block copolymer from about 50% to about 100%, e.g., from about 60% to about 100%, from about 70% to about 100%, from about 80% to about 100% or from about 90% to about 100%.

The reaction of the second step of the method may be represented generally according to the following schematic:

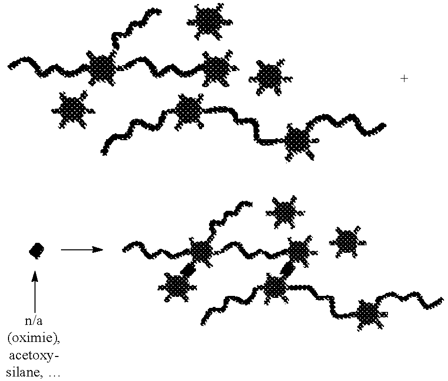

It is believed that reaction of step II crosslinks the trisiloxy blocks of the resin-linear organosiloxane block copolymer formed in step I, which will increase the average molecular weight of the block copolymer. The inventors also believe the crosslinking of the trisiloxy blocks provides the block copolymer with an aggregated concentration of trisiloxy blocks, which ultimately may help to form “nano-domains” in solid compositions of the block copolymer. In other words, this aggregated concentration of trisiloxy blocks may phase separate when the block copolymer is isolated in a solid form such as a film or cured coating. The aggregated concentration of trisiloxy block within the block copolymer and subsequent formation of “nano-domains” in the solid compositions containing the block copolymer, may provide for enhanced optical clarity of these compositions as well as the other physical property benefits associated with these materials.

The crosslinking reaction in Step II may be accomplished via a variety of chemical mechanisms and/or moieties. For example, crosslinking of non-linear blocks within the block copolymer may result from the condensation of residual silanol groups present in the non-linear blocks of the copolymer. Crosslinking of the non-linear blocks within the block copolymer may also occur between “free resin” components and the non-linear blocks. “Free resin” components may be present in the block copolymer compositions as a result of using an excess amount of an organosiloxane resin in step I of the preparation of the block copolymer. The free resin component may crosslink with the non-linear blocks by condensation of the residual silanol groups present on the non-linear blocks and on the free resin. The free resin may provide crosslinking by reacting with lower molecular weight compounds added as crosslinkers, as described below.

Step II of the present process may occur simultaneous upon formation of the resin-linear organosiloxane of step I, or involve a separate reaction in which conditions have been modified to affect the step II reaction. The step II reaction may occur in the same conditions as step I. In this situation, the step II reaction proceeds as the resin-linear organosiloxane copolymer is formed. Alternatively, the reaction conditions used for step I) are extended to further the step II reaction. Alternatively, the reaction conditions may be changed, or additional ingredients added to affect the step II reaction.

In some embodiments, the step II reaction conditions may depend on the selection of the hydrolyzable group (E) used in the starting linear organosiloxane. When (E) in the linear organosiloxane is an oxime group, it is possible for the step II reaction to occur under the same reaction conditions as step I. That is, as the linear-resin organosiloxane copolymer is formed in step I, it will continue to react via condensation of the silanol groups present on the resin component to further increase the molecular weight of the resin-linear organosiloxane copolymer. Not wishing to be bound by any theory, it is believed that when (E) is an oximo group, the hydrolyzed oximo group (for example methyl ethylketoxime) resulting from the reaction in step I may act as a condensation catalyst for the step II reaction. As such, the step II reaction may proceed simultaneously under the same conditions for step I. In other words, as the resin-linear organosiloxane copolymer is formed in step I, it may further react under the same reaction conditions to further increase its molecular weight via a condensation reaction of the silanol groups present on the resin component of the copolymer. However, when (E) on the linear organosiloxane is an acetoxy group, the resulting hydrolyzed group (acetic acid), does not sufficiently catalyze the step II) reaction. Thus, in this situation the step II reaction may be enhanced with a further component to affect condensation of the resin components of the resin-linear organosiloxane copolymer, as described in the example below.

In one example of the present process, an organosilane having the formula R⁵_{q}SiX_{4-q} is added during step II), where R⁵ is a C₁ to C₈ hydrocarbyl or a C₁ to C₈ halogen-substituted hydrocarbyl, X is a hydrolyzable group, and q is 0, 1, or 2. R⁵ is a C₁ to C₈ hydrocarbyl or a C₁ to C₈ halogen-substituted hydrocarbyl, or alternatively R⁵ is a C₁ to C₈ alkyl group, or alternatively a phenyl group, or alternatively R⁵ is methyl, ethyl, or a combination of methyl and ethyl. X is any hydrolyzable group, alternatively X may be E, as defined above, a halogen atom, hydroxyl (OH), or an alkoxy group. In one example, the organosilane is an alkyltriacetoxysilane, such as methyltriacetoxysilane, ethyltriacetoxysilane, or a combination of both. Commercially available representative alkyltriacetoxysilanes include ETS-900 (Dow Corning Corp., Midland, Mich.). Other suitable, non-limiting organosilanes useful in this example include; methyl-tris(methylethylketoxime)silane (MTO), methyl triacetoxysilane, ethyl triacetoxysilane, tetraacetoxysilane, tetraoximesilane, dimethyl diacetoxysilane, dimethyl dioximesilane, methyl tris(methylmethylketoxime)silane.

The amount of organosilane having the formula R⁵_{q}SiX_{4-q} when added during step II) varies, but should be based on the amount of organosiloxane resin used in the process.

The amount of silane used should provide a molar stoichiometry of 2 to 15 mole % of organosilane per moles of Si on the organosiloxane resin. Furthermore, the amount of the organosilane having the formula R⁵_{q}SiX_{4-q} added during step II) is controlled to ensure a stoichiometry that does not consume all the silanol groups on the organosiloxane block copolymer. In one example, the amount of the organosilane added in step II is selected to provide an organosiloxane block copolymer containing 0.5 to 35 mole percent of silanol groups [≡SiOH].

Step III in the present method is optional, and includes further processing the organosiloxane block copolymer formed using the aforementioned method steps to enhance storage stability and/or optical clarity. As used herein the phrase “further processing” describes any further reaction or treatment of the organosiloxane block copolymer to enhance storage stability and/or optical clarity. The organosiloxane block copolymer as produced in step II may include an amount of reactive “OZ” groups (e.g. ≡SiOZ groups, where Z is as described above), and/or X groups (where X is introduced into the organosiloxane block copolymer when the organosilane having the formula R⁵_{q}SiX_{4-q} is used in step II). The OZ groups present on the organosiloxane block copolymer at this stage may be silanol groups that were originally present on the resin component, or alternatively may result from the reaction of the organosilane having the formula R⁵_{q}SiX_{4-q} with silanol groups, when the organosilane is used in step II. Alternatively, further reaction of residual silanol groups may further enhance the formation of the resin domains and improve the optical clarity of the organosiloxane block copolymer. Thus, optional step III may be performed to further react OZ or X present on the organosiloxane block copolymer produced in Step II to improve storage stability and/or optical clarity. The conditions for step III may vary, depending on the selection of the linear and resin components, their amounts, and the endcapping compounds used.

In one example of the method, step III is performed by reacting the organosiloxane block copolymer from step II with water and removing any small molecular compounds formed in the method such as acetic acid. In this example, the organosiloxane block copolymer is typically produced from a linear organosiloxane where E is an acetoxy group, and/or an acetoxy silane is used in step II. Although not wishing to be bound by any theory, the organosiloxane block copolymer formed in step II may include a quantity of hydrolyzable Si—O—C(O)CH₃ groups, which may limit the storage stability of the organosiloxane block copolymer. Thus, water may be added to the organosiloxane block copolymer formed from step II, which may hydrolyze Si—O—C(O)CH₃ groups to further link the trisiloxy units, and eliminate acetic acid. The formed acetic acid, and any excess water, may be removed by known separation techniques. The amount of water added in this example may vary, but typically is 10 weight %, or alternatively 5 weight % is added per total solids (as based on organosiloxane block copolymer in the reaction medium).

In another example of the method, step III is performed by reacting the organosiloxane block copolymer from step II with an endcapping compound chosen from an alcohol, oxime, or trialkylsiloxy compound. In this embodiment, the organosiloxane block copolymer is typically produced from a linear organosiloxane where E is an oxime group. The endcapping compound may be a C₁-C₂₀ alcohol such as methanol, ethanol, propanol, butanol, or others in the series. Alternatively, the alcohol is n-butanol. The endcapping compound may also be a trialkylsiloxy compound, such as trimethylmethoxysilane or trimethylethoxysilane. The amount of endcapping compound may vary but typically is between 3 and 15wt % with respect to the organosiloxane block copolymer.

In some embodiments, step III includes adding to the resin-linear organosiloxane block copolymer from step II) a superbase catalyst or a stabilizer. The superbase catalyst and stabilizer amounts used in step III are the same as described above.

Step IV of the present process is optional, and involves removing the organic solvent used in the reactions of steps I and II. The organic solvent may be removed by any known techniques, but typically involves heating the resin-linear organosiloxane copolymer compositions at elevated temperature, either at atmospheric conditions or under reduced pressures. In some embodiments, not all of the solvent is removed. In this example, at least 20%, at least 30%, at least 40%, or at least 50% of the solvent is removed, e.g., at least 60%, at least 70%, at least 75%, at least 80% or at least 90% of the solvent is removed. In some embodiments, less than 20% of the solvent is removed, e.g., less than 15%, less than 10%, less than 5% or 0% of the solvent is removed. In other embodiments, from about 20% to about 100% of the solvent is removed, e.g., from about 30% to about 90%, from about 20% to about 80%, from about 30 to about 60%, from about 50 to about 60%, from about 70 to about 80% or from about 50% to about 90% of the solvent is removed.

In additional non-limiting embodiments, this disclosure includes one or more elements, components, method steps, test methods, etc., as described in one or more of Published PCT Appl. Nos. WO2012/040302; WO2012/040305; WO2012/040367; WO2012/040453; and WO2012/040457, all of which are expressly incorporated herein by reference.

### Method of Forming a Curable Silicone Composition:

A curable silicone composition may be formed using a method that includes the step of combining the solid composition and a solvent, as described above. The method may also include one or more steps of introducing and/or combining additional components, such as the organosiloxane resin and/or cure catalyst to one or both of the solid composition and the solvent. A solid composition and the solvent may be combined with each other and/or any other components using any method known in the art such as stirring, vortexing, mixing, etc.

### EXAMPLES

A series of examples including solid compositions and organosiloxane block copolymers are formed according to this disclosure. A series of comparative examples are also formed but not according to this disclosure. After formation, the examples and the comparative examples are formed into sheets which are then further evaluated.

### Example 1

A 500mL 4 neck round bottom flask is loaded with toluene (65.0 g) and Phenyl-T Resin (FW=136.6 g/mol Si; 35.0 g, 0.256 mols Si). The flask is equipped with a thermometer, Teflon stir paddle, and a Dean Stark apparatus prefilled with toluene and attached to a water-cooled condenser. A nitrogen blanket is then applied. An oil bath is used to heat the flask at reflux for 30 minutes. Subsequently, the flask is cooled to about 108° C. (pot temperature).

A solution of toluene (35.0 g) and silanol terminated PhMe siloxane (140 dp, FW=136.3 g/mol Si, 1.24 mol % SiOH, 65.0 g, 0.477 mols Si) is then prepared and the siloxane is capped with 50/50 MTA/ETA (Avg. FW=231.2 g/mol Si, 1.44 g, 0.00623 mols) in a glove box (same day) under nitrogen by adding 50/50 MTA/ETA to the siloxane and mixing at room temperature for 2 hours. The capped siloxane is then added to the Phenyl-T Resin/toluene solution at 108° C. and refluxed for about 2 hours.

After reflux, the solution is cooled back to about 108° C. and an additional amount of 50/50 MTA/ETA (Avg. FW=231.2 g/mol Si, 6.21 g, 0.0269 mols) is added and the solution is then refluxed for an additional hour.

Subsequently, the solution is cooled to 90° C. and then 12 mL of DI water is added. The solution including the water is then heated to reflux for about 1.5 hours to remove the water via azeotropic distillation. The addition of water and subsequent reflux is then repeated. A total amount of aqueous phase removed is about 27.3 g.

Subsequently, some toluene (about 54.0 g) along with most residual acetic acid is then distilled off (for about 20 minutes) to increase the solids content.

The solution is then cooled to room temperature and the solution is pressure filtered through a 5.0 μm filter to isolate the solid composition.

The solid composition is analyzed by ²⁹Si NMR which confirms a structure of D^{PhMe}_{0.635}T^{Alkyl}_{0.044}T^{Cyclohexyl}_{0.004}T^{Ph}_{0.317} with an OZ of about 11.8 mol %.

### Example 2

A 2 L 3 neck round bottom flask is loaded with toluene (544.0 g) and 216.0 g of the Phenyl-T resin described above. The flask is equipped with a thermometer, Teflon stir paddle, and a Dean Stark apparatus, prefilled with toluene, attached to a water-cooled condenser. A nitrogen blanket is applied. A heating mantle is used to heat the solution at reflux for 30 minutes. The solution is then cooled to 108° C. (pot temperature).

A solution of toluene (176.0 g) and 264.0 g of the silanol terminated PhMe siloxane described above is prepared and the siloxane is capped with 50/50 MTA/ETA (4.84 g, 0.0209 mols Si) in a glove box (same day) under nitrogen by adding the MTA/ETA to the siloxane and mixing at room temperature for 2hrs, as also described above.

The capped siloxane is then added to the Phenyl-T Resin/toluene solution at 108° C. and refluxed for about 2 hours.

After reflux, the solution is cooled back to about 108° C. and an additional amount of 50/50 MTA/ETA (38.32 g, 0.166 mols Si) is added and the solution is then refluxed for an additional 2 hours.

Subsequently, the solution is cooled to 90° C. and then 33.63 g of DI water is added.

The solution including the water is then heated to reflux for about 2 hours to remove the water via azeotropic distillation. The solution is then heated at reflux for 3hrs. Subsequently, the solution is cooled to 100° C. and then pre-dried Darco G60 carbon black (4.80 g) is added thereto.

The solution is then cooled to room temperature with stirring and then stirred overnight at room temperature. The solution is then pressure filtered through a 0.45 μm filter to isolate the solid composition.

The solid composition is analyzed by ²⁹Si NMR which confirms a structure of D^{PhMe}_{0.519}T^{Alkyl}_{0.050}T^{Ph}_{0.431} with an OZ of about 22.2 mol %. No acetic acid is detected in the solid composition using FT-IR analysis.

### Example 3

A 500 mL 3-neck round bottom flask is loaded with toluene (86.4 g) and 33.0 g of the Phenyl-T resin described above. The flask is equipped with a thermometer, Teflon stir paddle, and a Dean Stark apparatus, prefilled with toluene, attached to a water-cooled condenser. A nitrogen blanket is applied. A heating mantle is used to heat the solution at reflux for 30 minutes. The solution is then cooled to 108° C. (pot temperature).

A solution of toluene (25.0 g) and 27.0 g of the silanol terminated PhMe siloxane described above is prepared and the siloxane is capped with Methyl tris(methylethylketoxime)silane ((MTO); MW=301.46) in a glove box (same day) under nitrogen by adding the MTA/ETA to the siloxane and mixing at room temperature for 2hrs, as also described above.

The capped siloxane is then added to the Phenyl-T Resin/toluene solution at 108° C. and refluxed for about 3 hours. As described in greater detail below, films are then cast from this solution. The organosiloxane block copolymer in the solution is analyzed by ²⁹Si NMR which confirms a structure of D^{PhMe}_{0.440}T^{Me}_{0.008}T^{Ph}_{0.552} with an OZ of about 17.0 mol %. No acetic acid is detected in the solid composition using FT-IR analysis.

### Example 4

A 5 L 4 neck round bottom flask is loaded with toluene (1000.0 g) and 280.2 g of the Phenyl-T resin described above. The flask is equipped with a thermometer, Teflon stir paddle, and a Dean Stark apparatus, prefilled with toluene, attached to a water-cooled condenser. A nitrogen blanket is applied. A heating mantle is used to heat the solution at reflux for 30 minutes. The solution is then cooled to 108° C. (pot temperature).

A solution of toluene (500.0 g) and 720.0 g of a silanol terminated PDMS (FW=74.3 g/mol Si; ˜1.01 mol % OH) is prepared and the PDMS is capped with 50/50 MTA/ETA (23.77 g, 0.1028 mols Si) in a glove box (same day) under nitrogen by adding the MTA/ETA to the siloxane and mixing at room temperature for 30 minutes, as also described above.

The capped PDMS is then added to the Phenyl-T Resin/toluene solution at 108° C. and refluxed for about 3 hours fifteen minutes.

After reflux, the solution is cooled back to about 108° C. and an additional amount of 50/50 MTA/ETA (22.63 g, 0.0979 mols Si) is added and the solution is then refluxed for an additional 1 hour.

Subsequently, the solution is cooled to 100° C. and then 36.1 g of DI water is added.

The solution including the water is then heated at 88-90° C. for about 30 minutes and then heated at reflux for about 1.75 hours to remove about 39.6 grams of water via azeotropic distillation. The solution is then left overnight to cool.

Subsequently, the solution heated to reflux for 2 hours and then allowed to cool to 100° C. To reduce the acetic acid level, 126.8 g of DI water is then added and azeotropically removed over a 3.25 hr time period. The amount removed from the Dean Stark apparatus is about 137.3 g. The solution is then cooled to 100° C. Subsequently, 162.8 g of water is then added and then azeotropically removed over a 4.75 hr time period. The amount removed from the Dean Stark apparatus is about 170.7 g. The solution is then cooled to 90° C. and 10 g of Darco G60 carbon black is added thereto. The solution is then cooled to room temperature with stirring and then allowed to stir overnight at room temperature.

The solution is then pressure filtered through a 0.45 μm filter to isolate the solid composition.

The solid composition is analyzed by ²⁹Si NMR which confirms a structure of D^{Me2}_{0.815}T^{Alkyl}0.017T^{Ph}_{0.168} with an OZ of about 6.56 mol %. No acetic acid is detected in the solid composition using FT-IR analysis.

### Example 5

A 12 L 3 neck round bottom flask is loaded with toluene (3803.9 g) and 942.5 g of the Phenyl-T resin described above. The flask is equipped with a thermometer, Teflon stir paddle, and a Dean Stark apparatus, prefilled with toluene, attached to a water-cooled condenser. A nitrogen blanket is applied. A heating mantle is used to heat the solution at reflux for 30 minutes. The solution is then cooled to 108° C. (pot temperature).

A solution of toluene (1344 g) and 1829.0 g of the silanol terminated PDMS described immediately above is prepared and the PDMS is capped with MTO (Methyl tris(methylethylketoxime)silane (85.0 g, 0.2820 mols Si)) in a glove box (same day) under nitrogen by adding the MTO to the siloxane and mixing at room temperature for 2 hours, as also described above.

The capped PDMS is then added to the Phenyl-T Resin/toluene solution at 110° C. and refluxed for about 2 hours ten minutes. Subsequently, 276.0 g of n-butanol is added and the solution is then refluxed for 3 hours and then allowed to cool to room temperature overnight.

Subsequently, about 2913 g of toluene is removed by distillation to increase a solids content to ˜50 weight %. A vacuum is then applied at 65-75° C. for ˜2.5 hrs. Then, the solution is filtered through a 5.0 μm filter after setting for 3 days to isolate the solid composition.

The solid composition is analyzed by ²⁹Si NMR which confirms a structure of D^{Me2}_{0.774}T^{Me}_{0.009}T^{Ph}_{0.217} with an OZ of about 6.23 mol %. No acetic acid is detected in the solid composition using FT-IR analysis.

### Example 6

A 1 L 3 neck round bottom flask is loaded with toluene (180.0 g) and 64.9 g of the Phenyl-T resin described. The flask is equipped with a thermometer, Teflon stir paddle, and a Dean Stark apparatus, prefilled with toluene, attached to a water-cooled condenser. A nitrogen blanket is applied. A heating mantle is used to heat the solution at reflux for 30 minutes. The solution is then cooled to 108° C. (pot temperature).

A solution of toluene (85.88 g) and 115.4 g of the silanol terminated PDMS is prepared and the PDMS is capped with ETS 900 (50 wt % in toluene; Average FW=232/4 g/mol Si). in a glove box (same day) under nitrogen by adding ETS 900/toluene (8.25 g, 0.0177 mols Si) to the silanol terminated PDMS and mixing at room temperature for 2 hours.

The capped PDMS is then added to the Phenyl-T Resin/toluene solution at 108° C. and refluxed for about 2 hours.

Subsequently, the solution is cooled back to 108° C. and an additional amount of the ETS900 (15.94 g, 0.0343 mols Si) is added. The solution is then heated at reflux for one hour and then cooled back to 108° C. An additional amount of the ETS 900/toluene (2.23 g, 0.0048 mols Si) is then added and the solution is again heated at reflux for one hour.

Subsequently, the solution is cooled to 100° C. and 30 mL of DI water is added. The solution is again heated to reflux to remove water via azeotropic distillation. This process is repeated 3×.

Then, the solution is heated and ˜30 g of solvent is distilled off to increase the solids content. The solution is then cooled to room temperature and filtered through a 5.0 μm filter to isolate the solid composition.

The solid composition is analyzed by ²⁹Si NMR which confirms a structure of D^{Me2}_{0.751}T^{Alkyl}_{0.028}T^{Ph}_{0.221} with an OZ of about 7.71 mol %. No acetic acid is detected in the solid composition using FT-IR analysis.

### Example 7

Solid forms of the compositions prepared in Examples 1-6 may be generated using methods well known in the art. For example, flakes may be obtained by using a twin screw extruder to remove toluene from a toluene solution containing the compositions prepared in Examples 1-6, followed by grinding in the presence of dry ice in a household blender. A method that may be used to generate a powder includes, for example, spray drying of a toluene solution containing the compositions prepared in Examples 1-6.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1. A method for making an optical assembly, comprising:
depositing a solid silicone-containing hot melt composition in powder form onto an optical surface of an optical device; and
forming, from the silicone-containing hot melt composition, an encapsulant that substantially covers the optical surface of the optical device.

2. The method of claim 1, wherein the depositing and/or forming of the encapsulant comprises at least one of compression molding, lamination, extrusion, fluidized bed coating, electrophoretic deposition, injection molding, melt processing, electrostatic coating, electrostatic powder coating, electrostatic fluidized bed coating, transfer molding, magnetic brush coating.

3. The method of claim 1, further comprising depositing the silicone-containing hot melt composition onto a substrate to which the optical device is mechanically coupled.

4. The method of claim 1, wherein depositing the silicone-containing hot melt composition onto the optical surface comprises forming a first layer, and further comprising depositing a silicone-containing hot melt composition in a second layer on top of the first layer.

5. The method of claim 1, wherein the silicone containing hot melt composition is a reactive silicone-containing hot melt composition.

6. The method of claim 1, wherein the silicone containing hot melt composition is a non-reactive silicone-containing hot melt composition.

7. The method of claim 1, wherein the silicone-containing hot melt composition is a resin-linear silicone-containing hot melt composition and the composition comprises a phase separated resin-rich phase and a phase separated linear-rich phase.

8. The method of claim 7, wherein the resin-linear composition comprises:
40 to 90 mole percent disiloxy units of the formula [R¹₂SiO_{2/2}],
10 to 60 mole percent trisiloxy units of the formula [R²SiO_{3/2}],
0.5 to 35 mole percent silanol groups [≡SiOH];
wherein:
each R¹, at each occurrence, is independently a C₁ to C₃₀ hydrocarbyl,
each R², at each occurrence, is independently a C₁ to C₂₀ hydrocarbyl;
wherein:
the disiloxy units [R¹₂SiO_{2/2}] are arranged in linear blocks having an average of from 10 to 400 disiloxy units [R¹₂SiO_{2/2}] per linear block,
the trisiloxy units [R²SiO_{3/2}] are arranged in non-linear blocks having a molecular weight of at least 500 g/mole, and at least 30% of the non-linear blocks are crosslinked with each other and are predominately aggregated together in nano-domains, each linear block is linked to at least one non-linear block; and
the organosiloxane block copolymer has a molecular weight of at least 20,000 g/mole.

9. The method of claim 1, wherein the silicone-containing hot melt composition further comprises one or more phosphors and/or fillers.

10. The method of claim 1, wherein the silicone-containing hot melt composition is curable.

11. The method of claim 1, further comprising curing the silicone-containing hot melt composition via a curing mechanism.

12. The method of claim 11, wherein the curing mechanism comprises a hot melt cure, moisture cure, a hydrosilylation cure, a condensation cure, peroxide cure or a click chemistry-based cure.

13. The method of claim 11, wherein the curing mechanism is catalyzed by a curing catalyst.

14. A method of making an optical assembly comprising:
securing an optical device with respect to a substrate; and
depositing a solid silicone-containing hot melt composition in powder form onto at least one of a substrate and an optical surface of the optical device.

15. The method of claim 14, wherein the optical device is secured to the substrate prior to depositing the silicone-containing hot melt.

16. The method of claim 14, wherein depositing the silicone-containing hot melt composition substantially covers an entire area of the substrate.

17. The method of claim 14, wherein depositing the silicone-containing hot melt composition substantially only covers an area of the substrate between the substrate and the optical device.

18. The method of claim 14, wherein depositing the silicone-containing hot melt composition substantially only covers an area of the substrate not covered by the optical device.

19. The method of claim 14, wherein depositing the silicone-containing hot melt composition substantially covers only an area of the substrate not covered by the optical device and an optical surface of the optical device.

20. The method of claim 14, further comprising depositing a thin film encapsulant on the optical surface of the optical device, and wherein depositing the silicone-containing hot melt deposits the silicone-containing hot melt, at least in part, on the thin film encapsulant.

21. The method of claim 14, wherein depositing the silicone-containing hot melt forms a first layer of the silicone-containing hot melt, and further comprising depositing a second layer of the silicone-containing hot melt substantially on top of the first layer.

22. The method of claim 14, further comprising forming an encapsulant configured to encapsulate, at least in part, the optical device.

23. The method of claim 22, wherein depositing the silicone-containing hot melt deposits the silicone containing hot melt, at least in part, on the encapsulant.

24. The method of claim 22, wherein the silicone-containing hot melt is mixed with the encapsulant, and wherein depositing the silicone-containing hot melt composition comprises depositing both the silicone-containing hot melt composition and the encapsulant as a single composition.

25. A method of making an optical assembly comprising:
securing an optical device with respect to a substrate;
encapsulating, at least in part, the optical device with an encapsulant; and
depositing a solid silicone-containing hot melt composition in powder form onto the encapsulant.

26. The method of claim 25, wherein the encapsulant is a first encapsulant, and further comprising forming a second encapsulant on the silicone-containing hot melt composition, wherein the silicone-containing hot melt composition is between, at least in part, the first encapsulant and the second encapsulant.

27. A method of making an electronic device comprising:
securing an electronic component with respect to a substrate; and
depositing a solid silicone-containing hot melt composition in powder form onto the electronic component.

28. The method of claim 27, wherein the electronic device is at least one of a plastic leaded chip carrier (PLCC), a power package, a single-chip-on-board and a multi-chip-on-board.

29. The method of claim 27, further comprising forming, from the silicone-containing hot melt composition, an encapsulant that substantially covers the electronic component.

30. The method of claim 27, further comprising forming an encapsulant that substantially covers the electronic component and the silicone-containing hot melt composition.
